(19) United States
(12) Patent Application Publication
(10) Pub. No.: US 2011/0124398 A1
(43) Pub. Date: May 26, 2011

(54) CARD AND DICE WAGERING GAME

(76) Inventor: Michael S. Templeman, Trabuco Canyon, CA (US)

(21) Appl. No.: 12/969,301

(22) Filed: Dec. 15, 2010

Related U.S. Application Data
(63) Continuation-in-part of application No. 12/943,838, filed on Nov. 10, 2010.
Application No. 12/943,838 is a continuation-in-part of application No. 12/268,610, filed on Nov. 11, 2008.
(60) Provisional application No. 61/286,945, filed on Dec. 16, 2009.
(60) Provisional application No. 61/261,243, filed on Nov. 13, 2009.

(51) Int. Cl. G06F 17/00; A63F 9/04

(52) U.S. Cl. 463/22; 273/146

(57) ABSTRACT

In a card and dice game, dice are rolled to provide a die value between 2 and 12, inclusive, according to this embodiment. After the player makes a wager, a card is dealt face up, thereby displaying a card value of 1 to 13, inclusive. The player wins the wager if the card value is less than the die value and if the die value is less than a predetermined value. Similarly the player wins the wager if the card value is greater than the die value and if the die value is greater than the predetermined value. Otherwise the player loses the wager. If there is a tie (i.e., if the die value and the card value are equal), then one half (½) of the wager is returned to the player unless dice doubles were rolled, in which case the entire wager is returned.

### CROSS REFERENCE TO RELATED APPLICATIONS

This is a continuation-in-part application that claims priority from U.S. application Ser. No. 12/943,838, filed Nov. 10, 2010 which is a continuation-in-part application that claims priority from U.S. application Ser. No. 12/268,610, filed Nov. 11, 2008. The present application also claims benefit of U.S. Provisional Application No. 61/286,945, filed Dec. 16, 2009. Moreover U.S. application Ser. No. 12/943,838, filed Nov. 10, 2010, claims benefit of U.S. Provisional Application No. 61/261,243, filed Nov. 13, 2009. All four of the above-identified applications are incorporated herein by reference.

### FIELD OF INVENTION

This relates to gaming and card games. More particularly, this relates to methods and apparatuses for playing a new type of card and dice game especially for use in casino gaming, both in electronic video and live table formats.

### BACKGROUND

Wagering games are a prominent form of entertainment today. Gambling establishments, such as casinos, are appearing in every region. There are many wagering games, including bingo, roulette, card games such as blackjack, dice games such as craps and slot machines. Some people are attracted to wagering games because they experience a different feeling of excitement every time they bet in certain types of games. Also some people engage in gambling activities just for the sake of having fun.

Wagering activities include state lotteries; parimutuel betting on horses, greyhounds, and jai-alai; sports book-making; card games; keno; bingo; slot machines; video poker machines; video keno machines; video blackjack machines; and video roulette machines. These activities have grown greatly, especially when considering that most have only recently become legalized in many jurisdictions.

Casino gaming is a large part of the commercial gambling market. Customers gamble by playing slot machines or other games of chance (e.g., craps, roulette, baccarat) and some skill (e.g., blackjack, poker). Games usually have mathematically-determined odds that ensure the house has an advantage over the players at all times. This advantage is called the house edge. In games such as poker where players play against each other, the house takes a commission.

Casino-style gaming continues to grow in popularity, due in part to the rise in new casino destinations and the expansion of existing casino locales. A casino usually offers so-called banked games, i.e., where the house is banking the game and basically acting as a participant, and has a stake in who wins. On the other hand with a non-banked game, like the lottery, the operator does not care who wins.

For many players, the main goal of wagering games is recreation. However some players can become bored with any given game, at which point they likely will play that game less frequently. Thus there is a need for wagering games that are new, relatively simple to learn and play, and provide the excitement and interest necessary for entertainment.

### SUMMARY OF THE ILLUSTRATED EMBODIMENTS

Broadly speaking, certain embodiments of the invention relate to a casino-style card and dice game wherein a player bets against the house or a dealer on the outcome of a comparison of a numerical value determined by a roll of dice and another numerical value determined by a card drawn from a deck. According to one embodiment dice are thrown or rolled to provide a die value between 2 and 12, inclusive. If the die value is equal to a predetermined value, which in this embodiment is a value of seven (7), no betting is permitted, and the dice again are rolled and the process repeated until a die value which is not a seven (7) is rolled. After a successful roll of the dice, the die value is marked on a number grid located on a playing surface and displaying numbers ranging from 1 to 13, inclusive. After the player makes a wager, a card is dealt face up from one or more decks of playing cards, thereby displaying a card value of 1 to 13, inclusive.

The player wins the wager if the card value is less than the die value and if the die value is less than the predetermined value of seven (7). Similarly the player wins the wager if the card value is greater than the die value and if the die value is greater than the predetermined value of seven (7). Otherwise the player loses the wager. If there is a tie (i.e., if the die value and the card value are equal), then one half (½) of the wager is returned to the player unless dice doubles were rolled, in which case the entire wager is returned.

According to another embodiment, at least one die is rolled thereby generating a die value between 2 and 12, inclusive. A wager is established. A card is dealt thereby displaying a card value between 1 and 13, inclusive. The wager is paid (i.e., it is won by the player) if the card value is less than the die value and if the die value is less than a predetermined value of seven (7). Also the wager is paid if the card value is greater than the die value and if the die value is greater than the predetermined value of seven (7). On the other hand, the wager is taken (i.e., it is lost by the player): (a) if the die value is less than the predetermined value and if the card value is greater than the die value, or (b) if the die value is greater than the predetermined value and if the card value is less than the die value.

In one aspect the paying of the wager if the card value is less than the die value and if the die value is less than the predetermined value, includes paying the wager in accordance with a first predetermined pay scale having a first plurality of payout odds that vary as a function of the die value. Similarly, the paying of the wager if the card value is greater than the die value and if the die value is greater than the predetermined value includes paying the wager in accordance with a second predetermined pay scale having a second plurality of payout odds that vary as a function of the die value.

In another aspect, the variance as the function of the die value in the first predetermined pay scale is an increase in the payout odds corresponding to a decrease in the die value, and the variance as the function of the die value in the second predetermined pay scale is an increase in the payout odds corresponding to an increase in the die value.

In yet another embodiment, a wager is established based upon a prediction of one of a first game outcome and a second game outcome, wherein the first game outcome is a future card value being less than a future die value, and wherein the second game outcome is the future card value being greater than the future die value. At least one die is rolled thereby generating a present die value, and a card is dealt thereby displaying a present card value. The wager is paid if the present card value is less than the present die value and if the prediction is the first game outcome. Also the wager is paid if the present card value is greater than the present die value and if the prediction is the second game outcome. If the present card value is equal to the present die value (i.e., if there is a “tie”) then at least one half of the wager is returned to the player.

In one aspect, the rolling of the at least one die comprises rolling a first die thereby generating a first die value and rolling a second die thereby generating a second die value. The present die value is the sum of the first die value and the second die value. The returning of the at least one half of the wager (if there is a tie) includes returning all of the wager if doubles are rolled (i.e., if the first die value is equal to the second die value), but only returning one half of the wager if doubles are not rolled (i.e., if the first die value is not equal to the second die value).

In yet another embodiment, a first wager is established based upon a prediction of a first game outcome or a second game outcome. The first game outcome is a future card value being less than a future die value, and the second game outcome is the future card value being greater than the future die value. At least one die is rolled thereby generating a present die value. After the rolling of the at least one die, an option to establish a second wager is provided if the present die value is not equal to a predetermined value. A card is dealt thereby displaying a present card value. The first wager is paid: (a) if the present card value is less than the present die value and if the prediction is the first game outcome, or (b) if the present card value is greater than the present die value and if the prediction is the second game outcome. The second wager is paid if the option was exercised and: (a) if the present card value is less than the present die value and if the present die value is less than the predetermined value, or (b) if the present card value is greater than the present die value and if the present die value is greater than the predetermined value.

On the other hand, the first wager is taken: (a) if the present card value is less than the present die value and if the prediction is the second game outcome, or (b) if the present card value is greater than the present die value and if the prediction is the first game outcome. Also if the option was exercised the second wager is taken: (a) if the present card value is less than the present die value and if the present die value is greater than the predetermined value, or (b) if the present card value is greater than the present die value and if the present die value is less than the predetermined value.

In one aspect, the paying of the second wager when the present card value is less than the present die value and if the present die value is less than the predetermined value includes paying in accordance with a first predetermined pay scale having a first plurality of payout odds that vary as a function of the present die value. Also the paying of the second wager when the present card value is greater than the present die value and if the present die value is greater than the predetermined value, includes paying the second wager in accordance with a second predetermined pay scale having a second plurality of payout odds that vary as a function of the present die value.

In another aspect the variance as the function of the present die value in the first predetermined pay scale is an increase in the payout odds corresponding to a decrease in the present die value, and the variance as the function of the present die value in the second predetermined pay scale is an increase in the payout odds corresponding to an increase in the present die value.

In yet another aspect the dealing of the card includes dealing the card from at least one standard deck of 52 cards, wherein each card of the at least one standard deck of 52 cards has a point value between 1 and 13, inclusive, wherein the rolling of the at least one die includes rolling two dice each having six faces numbered one to six, and wherein the die value is a value between 2 and 12, inclusive, and wherein the predetermined value is a value of seven (7).

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 is a simplified diagram of a playing table layout according to an embodiment of the invention;

FIGS. 2A, 2B, 2C, 2D and 2E illustrate a simplified flow diagram of certain of the steps performed in playing a wagering game according to embodiments of the invention;

FIGS. 3A, 3B and 3C illustrate a simplified flow diagram of certain of the steps performed in playing a wagering game according to an alternative embodiment of the invention;

FIGS. 4A, 4B and 4C illustrate a simplified flow diagram of certain of the steps performed in playing a wagering game according to yet another alternative embodiment of the invention;

FIGS. 5A, 5B, 5C, 5D, 5E, 5F, 5G, 5H and 5I illustrate a simplified flow diagram of certain of the steps performed in playing a wagering game according to yet other alternative embodiments of the invention;

FIGS. 6A, 6B and 6C illustrate a simplified flow diagram of certain of the steps performed in playing a wagering game according to yet another alternative embodiment of the invention; and

FIG. 7 is a simplified functional block diagram of a computer according to an embodiment of the invention.

### DETAILED DESCRIPTION

The following description is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

Embodiments of the invention include a wagering game that uses one or more standard decks of playing cards (with 52 cards per deck and with no Joker cards) and two regular, six-sided dice. A player places a bet corresponding to his/her prediction of whether a future numerical value of a card to be drawn from the decks will be higher or lower than a future numerical value of the dice to be rolled or thrown. This bet is designated simply as an “over” or “under” bet, respectively. The dice are then thrown or rolled on a surface until they come to rest so that each die exposes a number on an exposed face of the die. The numbers of each die are added to provide a present die value between 2 and 12, inclusive.

The dealer next deals a card face up from the decks thereby displaying a present card value. The point value of the card is compared with the value of the previously-thrown dice to determine any winnings. That is, if the present card value turns out to be less than the present die value, the player will win if his/her first bet was an “under” bet. This “under” bet corresponds to the player's prediction that a future numerical card value would be lower than a future numerical die value. Otherwise, the player loses the bet. On the other hand, if the present card value turns out to be greater than the present die value, the player will win if the bet was an “over” bet. Otherwise the player loses. In the event of a tie (i.e., where the present card value equals the present die value), the player loses one half of the wager unless dice “doubles” were thrown, in which case all of the player's wager is returned to the player (i.e., a “push”).

In another embodiment, dice are thrown or rolled on a surface until they come to rest so that each die exposes a number on the upward face of the die. The numbers of each die are added to provide a die value between 2 and 12, inclusive. If the die value is equal to a predetermined value, which in this embodiment is a value of seven (7), no betting is permitted, and the dice are rolled once again and the process repeated until a die value of other than a seven (7) is rolled. After a successful roll of the dice, the die value is marked on a number grid located on the playing surface and displaying numbers ranging from 1 to 13, inclusive. After the player makes a wager, a card is dealt face up from one or more standard decks of playing cards (with 52 cards per deck and with no Joker cards) thereby displaying a card value of 1 to 13, inclusive.

The player wins the wager if the card value is less than the die value and if the die value is less than the predetermined value of seven (7). Similarly the player wins the wager if the card value is greater than the die value and if the die value is greater than the predetermined value of seven (7). Otherwise the player loses the wager. If there is a tie (i.e., if the die value and the card value are equal), then one half (½) of the wager is returned to the player unless dice doubles were rolled, in which case the entire wager is returned.

Winning wagers are paid in accordance with two predetermined pay scales. For winning wagers arising when the card value is less than the die value and the die value is less than the predetermined value of seven (7), the payout is in accordance with a first predetermined pay scale. This scale has a first plurality of payout odds that increase in payout as the die value decreases according to the following schedule:

| Die Value | Payout Odds |
|---|---|
| 6 | 7 to 5 |
| 5 | 2 to 1 |
| 4 | 3 to 1 |
| 3 | 5 to 1 |
| 2 | 11 to 1 |

For winning wagers arising when the card value is greater than the die value and the die value is greater than the predetermined value of seven (7), the payout is in accordance with a second predetermined pay scale. This scale has a second plurality of payout odds that increase in payout as the die value increases according to the following schedule:

| Die Value | Payout Odds |
|---|---|
| 8 | 7 to 5 |
| 9 | 2 to 1 |
| 10 | 3 to 1 |
| 11 | 5 to 1 |
| 12 | 11 to 1 |

Referring to the above two tables, if for example the die value is a four (4), then the player would win at a payout of 3 to 1 if a card was drawn from a deck thus displaying a card value of a 3, 2 or 1 (i.e., Ace). Similarly if for example the die value is a nine (9), then the player would win at a payout of 2 to 1 if a card was drawn from a deck thus displaying a card value of a 10, 11 (i.e. Jack), 12 (i.e. Queen) or 13 (i.e. King).

In yet another embodiment, a player places a bet. The dice are then thrown or rolled on a surface until they come to rest so that each die exposes a number on the upward face of the die. The numbers of each die are added to provide a die value between 2 and 12, inclusive. The dealer deals a card face up from the decks thereby displaying a card value. The point value of the card is compared with the value of the previously-thrown dice and the difference (or “spread”) between the two values is determined. That is, if the card value turns out to be less than the die value, then the card value is subtracted from the die value to determine the spread. On the other hand, if the card value turns out to be greater than the die value, the die value is subtracted from the card value to determine the spread. Regardless of which method is used to determine the spread, once it has been determined this amount is compared to a predetermined pay scale. If the spread is less than a predetermined minimum amount, the bet loses. If the spread is equal to or greater than the predetermined amount, then the bet wins and is paid according to the pay scale that provides for a greater payout as a function of a larger spread magnitude.

The pay scale can be designed with any number of different parameters, payouts or predetermined minimum amounts and not impact the spirit of certain embodiments the invention. An exemplary pay scale having higher payouts as the magnitude of the difference or spread, is increased, is set forth in the following pay table:

| Spread | Payout |
|---|---|
| 6 | 1 to 1 |
| 7 | 2 to 1 |
| 8 | 3 to 1 |
| 9 | 5 to 1 |
| 10 | 10 to 1 |
| 11 | 30 to 1 |

Referring to this table, if for example the roll of the dice results in a die value of 2, and the card that was dealt results in a card value of 8, the spread between these values would be 6. The wager would be paid 1 to 1 (or sometimes designated as “1:1”) according to the pay table. However, if after the same die value of 2, the card that was dealt results in a card value of 10, the spread would be 8 and the wager would be paid at a higher amount, such as 3 to 1, according to the above pay table. (By a payout of “1 to 1” it is meant, for example, that for every dollar that was bet, the player would receive back two dollars, representing the original one dollar bet plus another dollar. A payout of “3 to 1” would mean, for example, that the player would receive back four dollars for every one dollar bet, etc.)

It should also be noted that similar spread magnitudes and similar payouts can be achieved where a die value is greater than a card value, such as for example when a dice roll results in a die value of 10 and a card that was dealt results in a card value of 4. This condition would also result in a spread of 6 and would similarly be paid 1 to 1 according to the exemplary pay table. A spread of 8 would also result if the dice roll resulted in a die value of 10 and the dealt card resulted in a card value of 2. The resulting spread of 8 would similarly be paid 3 to 1 per the exemplary pay table. Finally it should be noted that in the above example, any spread that is less than the predetermined amount of 6 will result in a loss of the wager.

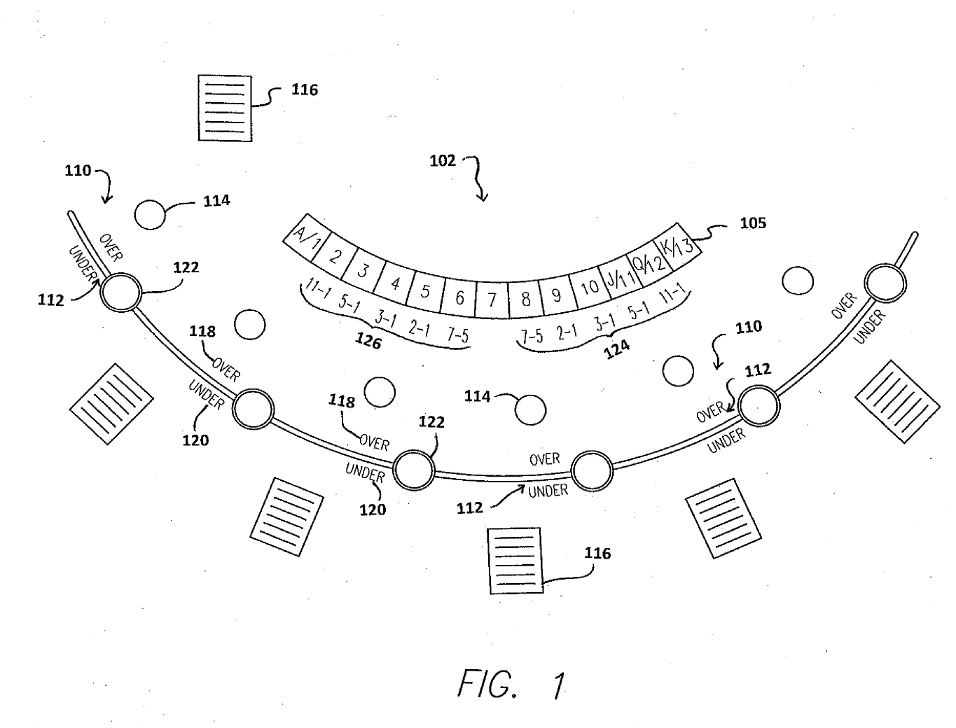

FIG. 1 is a simplified diagram of a playing table layout 102 according to one embodiment of the invention. The layout 102 includes a number grid 105 used by the dealer to mark the outcome of a dice roll. Around the perimeter of one edge (not shown) of a table surface are a plurality of individual player betting areas 110 for use by the players. Each of the betting areas 110 includes a first location 112 where one bet can be placed, a second location 114 where a second bet can be placed, and a third location 122 where a third bet can be placed. Each betting area 110 further includes a location for a first pay table 116 that includes printed information relating to the payout of bets pursuant to a first predetermined pay scale. In one embodiment the pay table 116 would include printed information that is similar to one of the exemplary pay tables illustrated above. Located adjacent to the number grid 105 is a first plurality of payout odds 124 for a second predetermined pay scale that is similar in content to one of the exemplary pay tables illustrated above. Adjacent to the number grid 105 and the first plurality of payout odds 124 is a second plurality of payout odds 126 for a third predetermined pay scale that is similar in content to another one of the pay tables illustrated above.

While FIG. 1 illustrates a table layout 102 and player stations or betting areas 110 according to one embodiment, it will be appreciated that alternative table layouts and arrangements can be used without departing from the spirit of the inventions. The illustrated table layout 102 and player betting areas 110 are just one of many arrangements that can be employed to facilitate the placement of wagers by one or more players and the amount of the wagers and payouts can be quickly and easily determined by the casino dealer as well as the players.

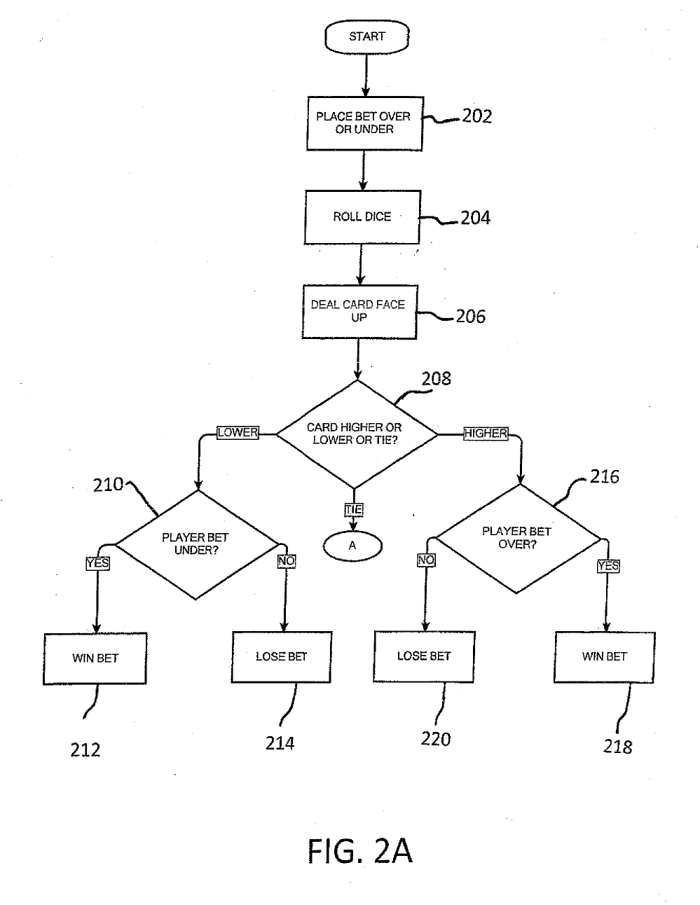

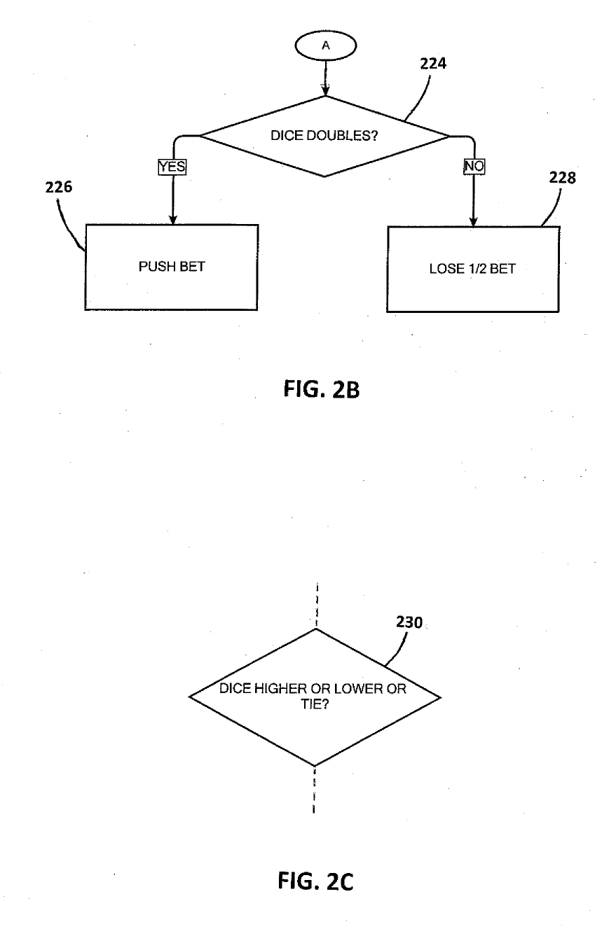

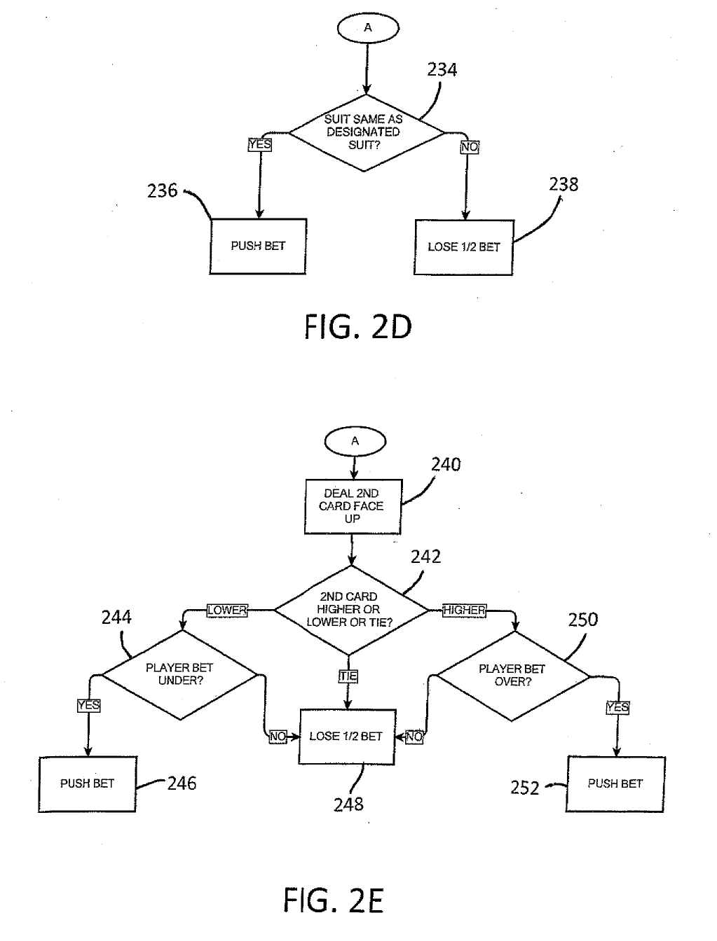

FIGS. 2A and 2B are a simplified process flow diagram of a method of playing a wagering game according to one embodiment of the invention. This is relatively simple way to play this novel wagering game in that there is no second or other wager option. In this embodiment, a first random number is generated with dice, and a second random number is generated with cards. The dice comprise two, standard dice, each having six faces numbered 1 to 6. Thus when the two dice are thrown, a generally random die number between 2 and 12, inclusive, will be generated by adding the values of both dice. The cards comprise at least one standard deck of 52 playing cards without any Joker cards, i.e., wherein a deck includes four suits of cards with each suit having cards with face designations or indicia associated with point values of 2 through 10, as well as a Jack, Queen, King and Ace. Thus when a card is drawn from at least one properly shuffled deck, a generally random card value between 1 and 13, inclusive, will be generated according to a point value assigned to the card face indicia of each card as set forth in the following chart:

| Card Face Indicia | Assigned Point Value |
|---|---|
| Ace | 1 |
| Two | 2 |
| Three | 3 |
| Four | 4 |
| Five | 5 |
| Six | 6 |
| Seven | 7 |
| Eight | 8 |
| Nine | 9 |
| Ten | 10 |
| Jack | 11 |
| Queen | 12 |
| King | 13 |

Still referring to FIGS. 2A and 2B, at the start of the game a player decides whether to bet “over” or “under” and places a wager on the betting table at a location on the table that designates the nature of the player's decision. (Step 202) For a betting table having the layout as shown in FIG. 1, the wager would be placed in the first location 112, and more specifically in an “over” bet location 118 for an “over” bet or in an “under” bet location 120 for an “under” bet. This wager amounts to a prediction by the player of one of two game outcomes: either a future card value will be less than a future die value (i.e., an “under” bet) or the future card value will be greater than the future die value (i.e., an “over” bet). In alternative embodiments, other designations can be used in the place of the “over” and “under” designations. For example the designations could be a “high” bet in lieu of the “over” bet designation, and a “low” bet in lieu of the “under” bet designation.

Next the two dice are rolled thereby generating a die value which is observed by the player. (Step 204) This die value will be a value between 2 and 12, inclusive, as determined by adding the values of the two dice. Then a single card is dealt face up from one or more decks of shuffled cards thereby displaying a card value, which will be a value between 1 and 13, inclusive, as determined by the above chart. (Step 206) The card value is compared with the die value, and a determination is made whether the card value is higher than the die value, lower than the die value or tied with the die value. (Step 208)

If the card value is lower than the die value, then a determination is made whether in step 202 the player had made an “under” bet, i.e. a prediction by the player that a future card value will be lower than a future die value. (Step 210) If the player had bet “under,” then the wager is paid, i.e., he/she wins the wager. (Step 212) In such event, the amount paid to the player would be at an odds or payout of 1 to 1, i.e., for example for every one dollar that was wagered in step 202, the player would receive two dollars—representing the one dollar that the player initially wagered along with another one dollar paid as winnings Returning to step 210, if on the other hand the player had not bet “under” (in other words, the player in fact had bet “over”), then the wager is taken, i.e., the player loses the wager. (Step 214)

Returning now to step 208, if on the other hand the card value turned out to be higher than the die value, then a determination is made whether in step 202 the player had made an “over” bet, i.e., a prediction by the player that a future card value will be higher than a future die value. (Step 216) If the player did bet “over,” then the wager is paid and the player receives a payout of 1 to 1. (Step 218) If on the other hand the player had not bet “over” (in other words, he/she in fact had bet “under”), then the wager is taken or lost. (Step 220) Returning again to step 208, if on the other hand there is a tie, i.e., the card value is equal to the die value, then a determination is made whether the dice roll had been a roll of “doubles”, i.e., whether there had been rolled a pair of “1's”, a pair of “2's”, a pair of “3's”, a pair of “4's”, a pair of “5's” or a pair of “6's.” (Step 224) If there had been a roll of doubles, then there is a “push” of the wager, i.e., the player's wage is returned in full to the player without any winnings or loss. (Step 226) On the other hand if there had not been a roll of doubles, then the player loses one half (½) of the wager, and one half (½) of the wager is returned to the player. (Step 228)

The embodiment of FIGS. 2A and 2B involves a game outcome prediction relating to whether a card value will be higher or lower than a die value. In an alternative embodiment however this is reversed. That is, the player bets on a game outcome prediction relating to whether a die value will be higher or lower than a card value. In this embodiment, the steps of FIGS. 2A and 2B are generally the same. However in step 202, the difference is that a player's “under” bet amounts to a prediction that a future die value will be less than a future card value, and an “over” bet amounts to a prediction that the future die value will be greater than the future card value. Also in this alternative embodiment, the decision step 208 of FIG. 2A is replaced by decision step 230 shown in FIG. 2C wherein the dice and card values are compared, and a determination is made whether the die value is higher than the card value, lower than the card value or tied with the card value. In yet a further alternative embodiment, not only is the decision step 230 of FIG. 2C substituted, but also the order of performing steps 204 and 206 of FIG. 2A is reversed so that the card is dealt prior to the dice being rolled.

The embodiment of FIGS. 2A and 2B involves a question of whether or not there had been a roll of doubles to determine how much of the bet is lost by the player when the die value and the card value are the same. In another embodiment, one or more of the card suits (e.g., Spades, Hearts, Diamonds or Clubs as contained in a standard deck of 52 playing cards without jokers) will be designated. The designation may be determined, for example, by the marking of a particular space on the playing surface, by drawing another card from a deck and using the suit of that card as the designation, or by displaying a sign or other indicia indicating the designated suit or suits at the table. Regardless of how the suit designation is determined, if the suit of the card that was dealt to determine the present card value is the same as the previously-designated suit, then the wager is returned in full to the player if there is a tie. Otherwise one half of the wager is lost.

FIGS. 2A and 2D illustrate an embodiment involving the use of a designated suit for determining the nature of any return of a wager when there is a tie. Steps 202-220 of FIG. 2A are the same as previously described. However referring to step 208 if it is determined that there is a tie, then a determination is made whether the suit of the card that was dealt in step 206 is the same as the designated suit. (Step 234) If the suit of the card is the same as the designated suit, then there is a push. (Step 236) On the other hand if the suit of the card is not the same as the designated suit, then the player loses one half of the bet. (Step 238)

In yet another embodiment, any return of a wager arising from a tie is determined by dealing a second card thereby displaying a second card value. If the second value would have caused the wager to have won had the second card been dealt in place of the originally-dealt card, then the player's wager would be returned to the player, i.e., a “push.” If the second card value would not have caused the wager to have won had the second card been dealt in place of the originally-dealt card, then one half of the wager is lost.

FIGS. 2A and 2E illustrate an embodiment involving the use of a second card for determining the nature of any return of a wager when there is a tie. Steps 202-220 of FIG. 2A are the same as previously described. However according to this embodiment if at step 208 it is determined that there is a tie, then a second card is dealt face up thereby displaying a second card value. (Step 240) The second card value is compared with the die value and a determination is made whether the second card value is higher, lower or equal to the die value. (Step 242) If the second card value is lower than the die value, then a determination is made whether in step 202 the player had made an “under” bet. (Step 244) If the player had made an “under” bet, then there is a push of the wager. (Step 246) On the other hand if an “under” bet had not been made (i.e., the player had bet “over”), then one half of the wager is lost. (Step 248)

Returning to step 242 if on the other hand the second card value is higher than the die value, then a determination is made whether in step 202 the player had made an “over” bet. (Step 250) If the player had made an “over” bet, then there is a push of the wager. (Step 252) On the other hand if an “over” bet had not been made (i.e., the player had bet “under”), then one half of the wager is lost. (Step 248) Returning again to step 242 if the second card value is equal to the die value (i.e., if there is a second tie), then one half of the wager is lost. (Step 248)

In the above-described embodiments of FIGS. 2A-2E, one or more dice are used for generating a generally random number for comparison with a card that is drawn from at least one deck. In alternative embodiments, however, cards can be substituted for the one or more dice in order to generate a generally random number. In one embodiment, a first deck of cards is used in lieu of the dice to generate a first card point value. A second deck of cards is used to generate a second card point value. The first and second card point values are compared to determine whether “over” and/or “under” bets are winning bets in the same fashion as the dice and card values are compared as described above for certain embodiments.

According to one embodiment, a first deck of cards is used in lieu of a first die and a second deck of cards is used in lieu of a second die. The first and second decks each are limited only to cards having values between 1 and 6, inclusive. One card is drawn from each of these two decks, and the face values of these two cards are added to provide a combined card point value between 2 and 12, inclusive, that substitutes for the dice value used in certain of the embodiments described above. A third card is drawn from a third deck thus displaying a third card point value between 1 and 13, inclusive. (In one embodiment, this third deck comprises at least one, standard deck of 52 playing cards per deck, but alternative types or designs of cards can be used as well.) The combined card point value is compared with the third card point value to determine whether “over” and/or “under” bets bets are winning bets.

In one embodiment, the first and second decks each comprises at least one each of an Ace card, a Two card, a Three card, a Four card, a Five card, and a Six card—all of which such cards have generally the same appearance as their counterparts as taken from a standard deck of 52 playing cards. Moreover, each of the first and second decks includes no cards other than the Ace, Two, Three, Four, Five and Six cards.

When there is a tie, i.e., when the third card point value is equal to the combined card point value, then the payout, if any, is handled in a manner that is analogous to that described above when dice are used. Thus for example, when there is a tie all of the wager is returned to the player if the first card point value is equal to the second card point value (which is a result that is analogous to the rolling of doubles when using dice), whereas only one half (½) of the wager is returned if the first card point value is not equal to the second card point value. In an alternative embodiment involving a tie, all of the wager is returned to the player if the third card is of a suit that is the same as a designated suit, whereas only one half (½) of the wager is returned if the third card is of a suit that is not the same as the designated suit. In yet another alternative embodiment involving a tie, a fourth card is dealt from the third deck thereby displaying a fourth card value. All of the wager is returned: (a) if the fourth card value is greater than the present combined card value and if the prediction is the second game outcome, or (b) if the fourth card value is less than the present combined card value and if the prediction is the first game outcome. On the other hand, only one half (½) of the wager is returned: (a) if the fourth card value is equal to or greater than the present combined card value and if the prediction is the first game outcome, or (b) if the fourth card value is equal to or less than the present combined card value and if the prediction is the second game outcome.

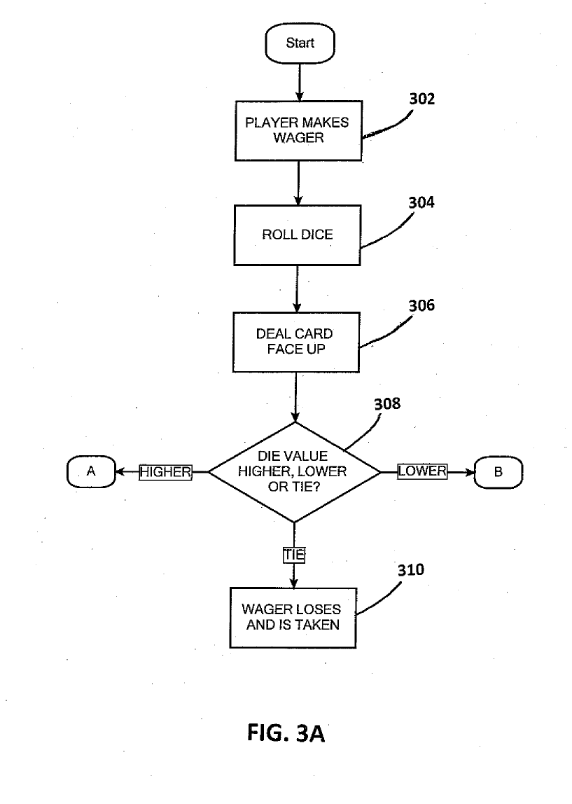

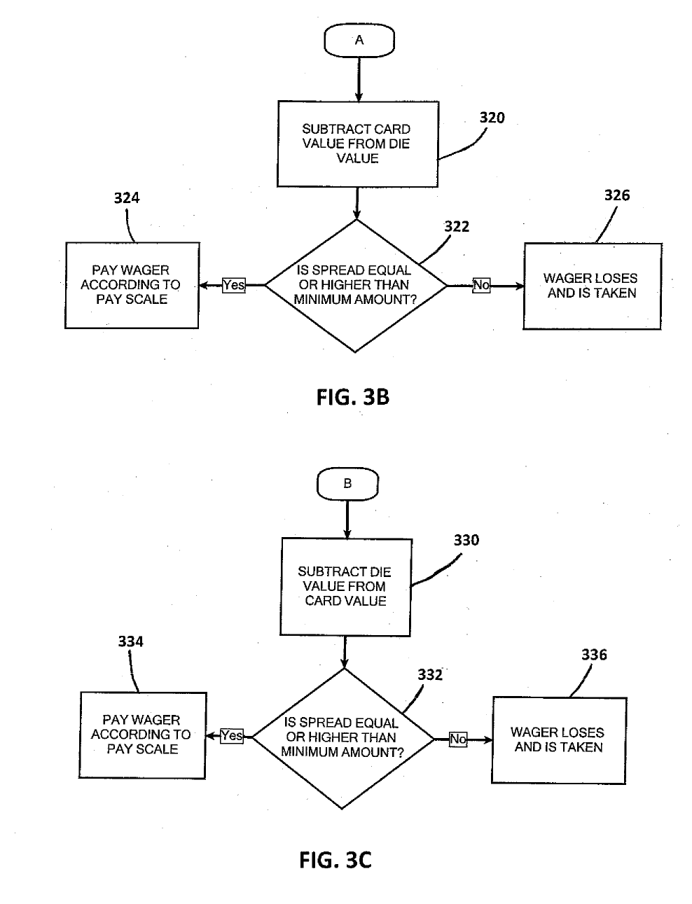

FIGS. 3A, 3B and 3C illustrate a simplified process flow diagram of a method of playing a wagering game according to another embodiment of the invention. In this embodiment, a first random number is generated with dice, and a second random number is generated with cards. The dice comprise two, standard dice, each having six faces numbered 1 to 6. Thus when the two dice are thrown, a generally random die number between 2 and 12, inclusive, will be generated by adding the values of both dice. The cards comprise at least one standard deck of 52 playing cards, i.e., wherein a deck includes four suits of cards with each suit having cards with face designations or indicia associated with point values of 2 through 10, as well as a Jack, Queen, King and Ace. Thus when a card is drawn from at least one properly shuffled deck, a generally random card number between 1 and 13, inclusive, will be generated according to a point value assigned to the card face indicia of each card as set forth in the above chart.

Referring to FIGS. 3A-3C, a player makes a wager on the betting table at a designated location on it. (Step 302) For a betting table having the layout as shown in FIG. 1, the wager would be placed in the second location 114. Next the two dice are rolled thereby generating a die value. (Step 304) This die value will be a value between 2 and 12, inclusive, as determined by adding the values of the two dice. The dealer announces the result of the roll and marks the present dice value on the table, such as for example on the number grid 105 of FIG. 1. Then a single card is dealt face up from the one or more decks of shuffled cards thereby displaying a card value, which will be a value between 1 and 13, inclusive, as determined by the above chart. (Step 306) The die value is compared with the card value, and a determination is made whether the die value is higher than the card value, lower than the card value or tied with the card value. (Step 308)

If the die value equals the card value, then there is a tie whereupon the player's wager loses and is taken. (Step 310) If the die value is higher than the card value, the card value is subtracted from the die value to determine the difference, or spread, between the two values. (Step 320) The spread is then compared to a predetermined amount, and a determination is made if the spread is equal to or higher than the predetermined amount. (Step 322)

Still referring to FIGS. 3A-3C, if the spread is equal to or higher than the predetermined amount, the player's wager wins and is paid in accordance with a predetermined pay scale having a plurality of payout odds that vary as a function of the magnitude of the spread. (Step 324) In one embodiment the winning wager is paid according to the pay table illustrated above. If the spread is neither equal to nor higher than the predetermined amount, the player's wager loses and is taken. (Step 326) Returning now to step 308, if on the other hand the die value is lower than the card value, then the die value is subtracted from the card value to determine the spread. (Step 330) The spread is then compared to the predetermined amount, and a determination is made if the spread is equal to or higher than the predetermined amount. (Step 332) If the spread is equal to or higher than the predetermined amount, the player's wager wins and is paid according to the predetermined pay scale. (Step 334) If the spread is neither equal to nor higher than the predetermined amount, the player's wager loses and is taken. (Step 336) In the above described embodiment, the predetermined amount is a value of six (6); however other predetermined amounts may be used in other embodiments.

In the embodiment of FIGS. 3A-3C, one or more dice are used for generating a generally random number for comparison with a card that is drawn from at least one, shuffled deck. In alternative embodiments, however, cards from special decks can be substituted for the one or more dice in order to generate a generally random number that would mimic the generally random number that results from the roll of one or more dice. In one embodiment, a first deck of cards is used in lieu of one die to generate a first card value, and a second deck of cards is used in lieu of a second die to generate a second card value. The first and second card values are summed to determine a combined card value. A third card is drawn from a third deck to determine a third card value. The combined card value and the third card value are compared to determine the spread. That is, the lower of the combined card value or third card value is subtracted from the higher of these values. Winning bets (and the amounts of the payouts) are determined in the same fashion as the embodiment described above in connection with FIGS. 3A-3C.

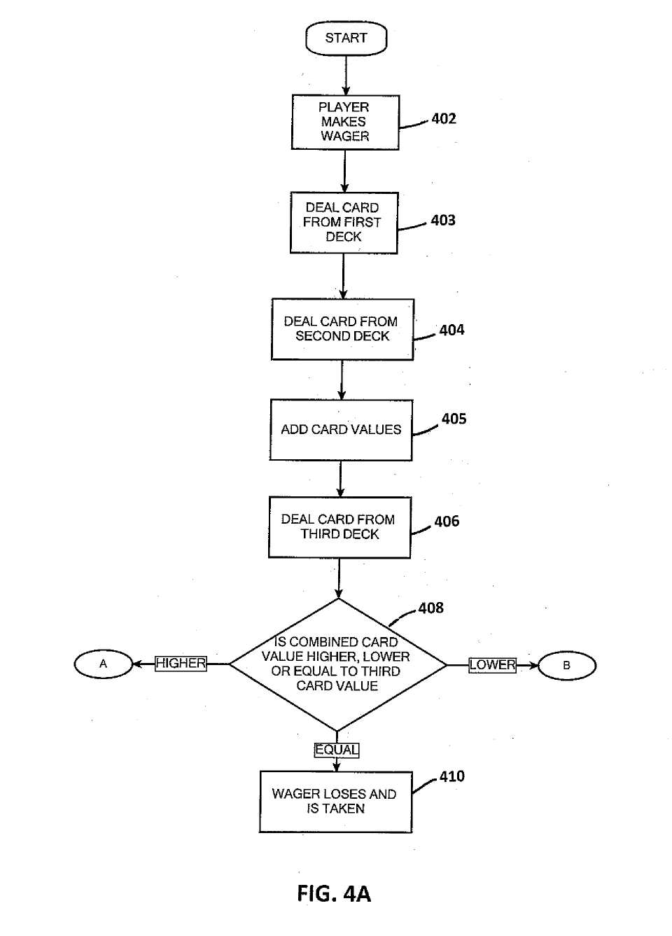

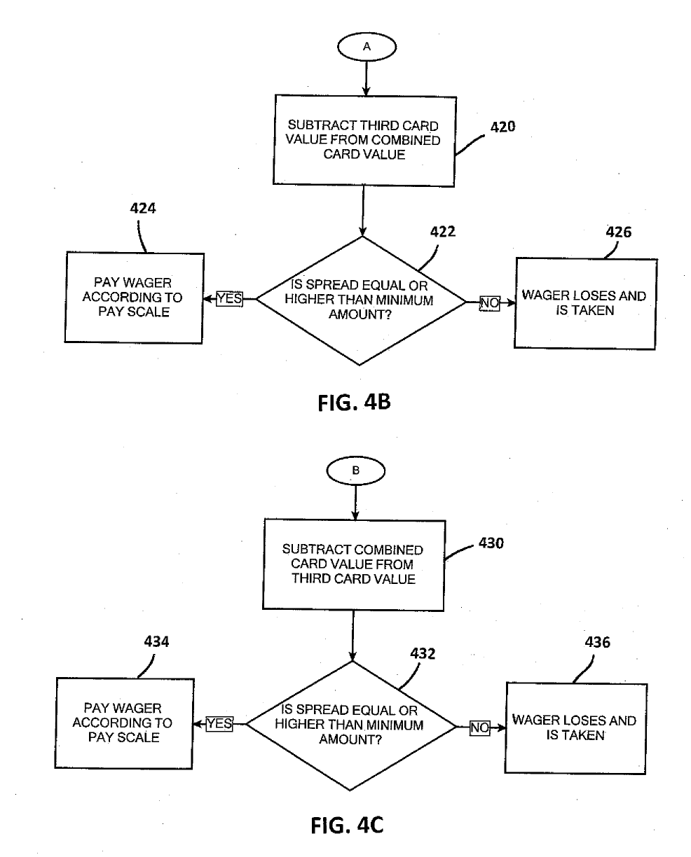

FIGS. 4A, 4B and 4C illustrate a simplified process flow diagram of an embodiment of the invention that uses a first deck of cards in lieu of a first die and a second deck of cards in lieu of a second die. The first and second decks are each limited to a plurality of cards having values between 1 and 6, inclusive. A player makes a wager (Step 402), after which one card is dealt from a first deck thereby displaying a present first card value. (Step 403) Similarly a card is dealt from a second deck thereby displaying a present second card value. (Step 404) The values of these two cards are added to determine a combined card value, which in this embodiment is a value between 2 and 12, inclusive. (Step 405) A third card is dealt from a third deck thus displaying a third card value between 1 and 13, inclusive, as determined by the chart described above. (Step 406)

The combined card value is compared with the third card value and a determination is made whether the combined card value is higher or lower or equal to the third card value. (Step 408) If the combined card value equals the third card value, then there is a tie and the player's wager is taken. (Step 410) On the other hand if the combined card value is higher than the third card value, the spread is determined by subtracting the third card value from the combined card value. (Step 420) The spread is then compared to a predetermined amount, and a determination is made as to whether the spread is equal to or higher than the predetermined amount. (Step 422) If the spread is equal to or higher than the predetermined amount, the player's wager wins and is paid in accordance with a predetermined pay scale having a plurality of payout odds that vary as a function of the magnitude of the spread. (Step 424) If the spread is neither equal to nor greater than the predetermined amount, the player's wager loses and is taken. (Step 426)

Returning now to step 408, if on the other hand the combined card value is lower than the third card value, then the combined card value is subtracted from the third card value to determine the spread. (Step 430) The spread is then compared to the predetermined amount, and a determination is made if the spread is equal to or higher than the predetermined amount. (Step 432) If the spread is equal to or greater than the predetermined amount, the player's wager wins and is paid in accordance with the predetermined pay scale. (Step 434) On the other hand if the spread is not equal to nor higher than the predetermined amount, the player's wager loses and is taken. (Step 436)

In the embodiment of FIGS. 4A-4C, the first and second decks are each comprised of at least one each of an Ace card, a Two card, a Three card, a Four card, a Five card, and a Six card—all of which such cards have generally the same appearance as their counterparts as taken from a standard deck of 52 playing cards. Moreover, each of the first and second decks includes no cards other than the Ace card, Two card, Three card, Four card, Five card and Six card. Finally, each of the first and second decks contains equal quantities of each of the Ace card, Two card, Three card, Four card, Five card, and Six card.

The above disclosure includes embodiments where one bet is based upon a prediction of whether a future card value will be over or under a future die value. Other disclosed embodiments include another bet that is based upon whether the spread between a die value and a card value will be equal to or greater than a predetermined amount. Alternative embodiments, however, can generally include the use both of these types of bets in a single game.

Thus for example according to one embodiment, a first wager is established based upon a prediction of a first game outcome or a second game outcome, wherein the first game outcome is a future card point value being less than a future die value, and wherein the second game outcome is the future card point value being greater than the future die value. Also an option to establish a second wager is provided. At least one die is rolled thereby generating a present die value. A card is dealt thereby displaying a present card value. The first wager is paid if the present card value is less than the present die value and if the prediction is the first game outcome. Also the first wager is paid if the present card value is greater than the present die value and if the prediction is the second game outcome. Moreover the second wager is paid if the option was exercised and if a difference between the present die value and the present card value is greater than or equal to a predetermined amount.

In one aspect of this embodiment at least one half of the first wager is returned if there is a tie, i.e., if the present card value is equal to the present die value. In another aspect, the second wager is taken if the option was exercised and if the difference between the present card value and the present die value is less than the predetermined amount.

In yet another aspect, if the second wager is won, it is paid in accordance with a predetermined pay scale having a plurality of payout odds that vary as a function of the magnitude of the difference between the present card value and the present die value.

While the second wager is optional in the foregoing embodiment, alternative embodiments include games where the second wager is not optional, so that it is a requirement for playing the game that both the first and second wagers be made.

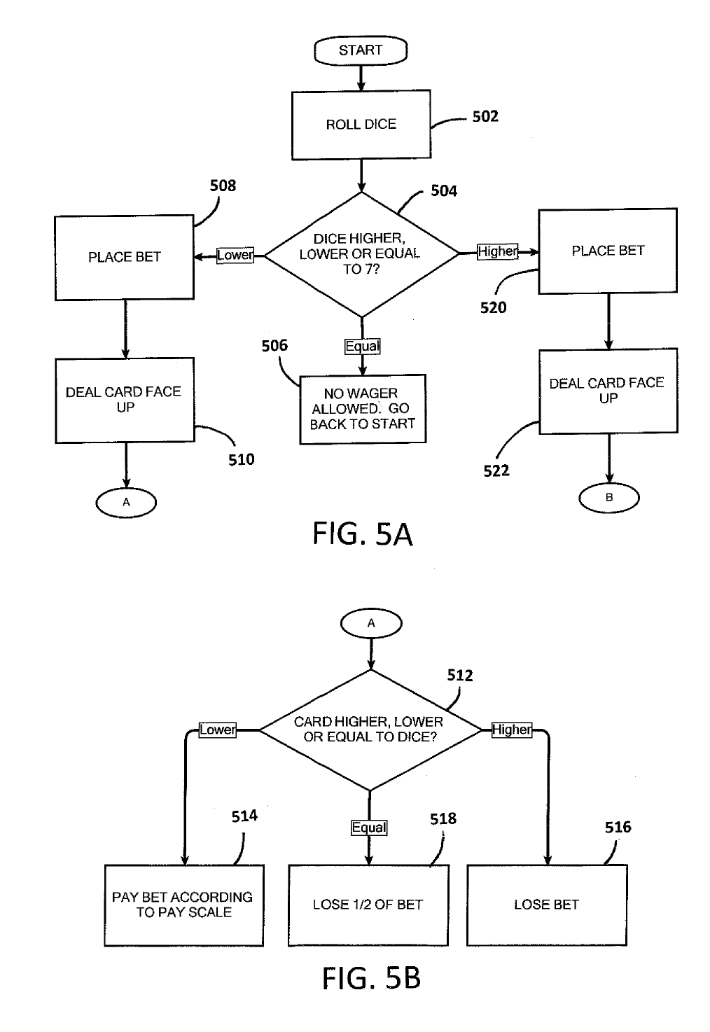

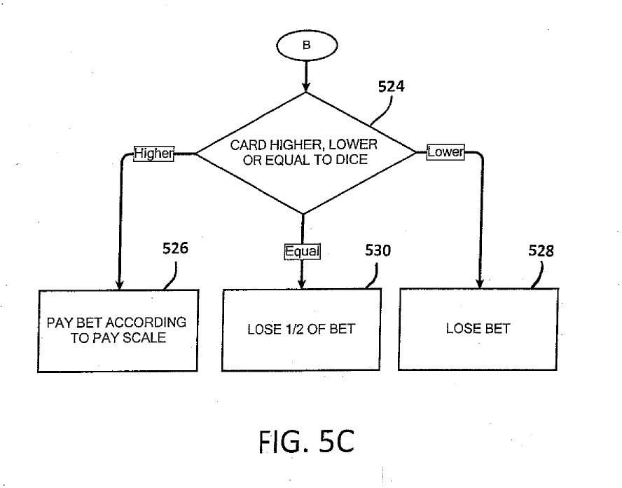

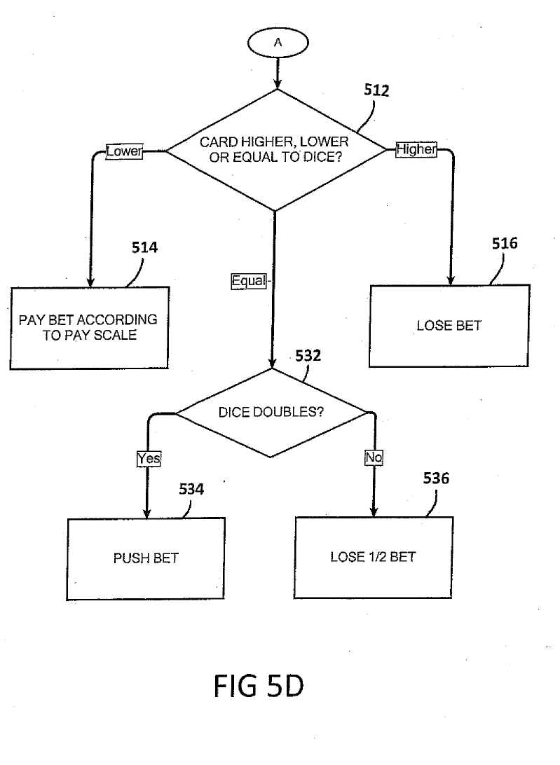

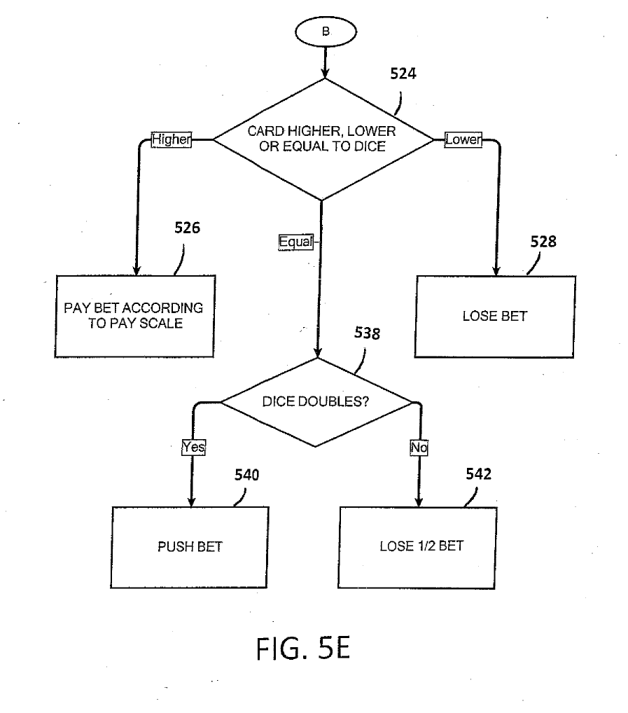

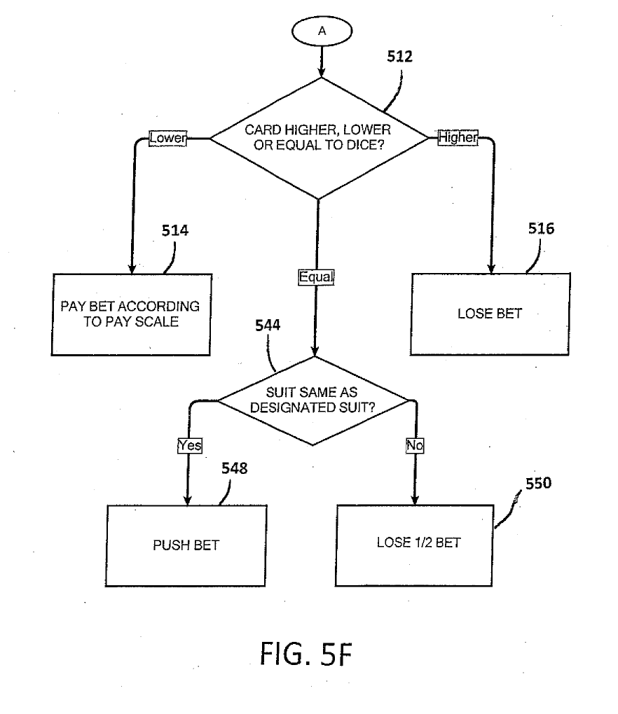

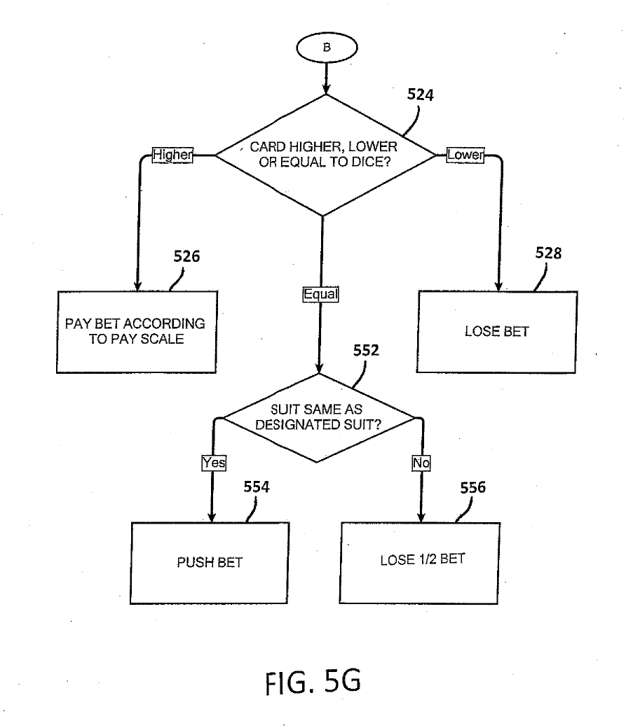

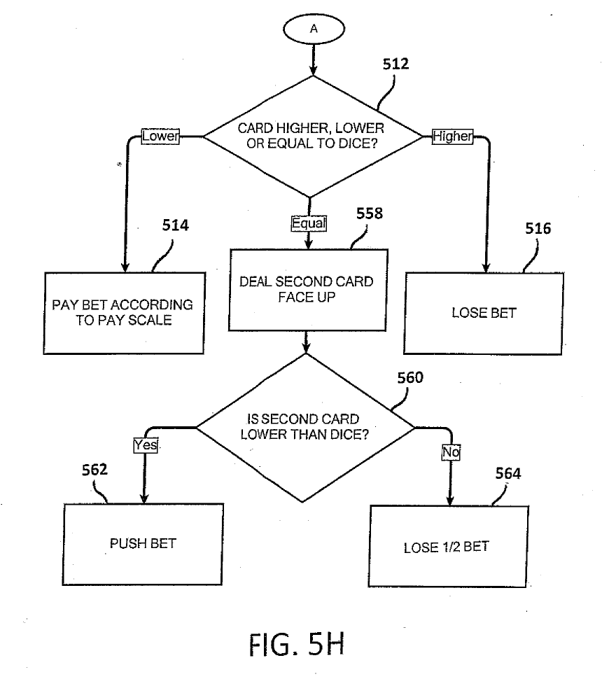

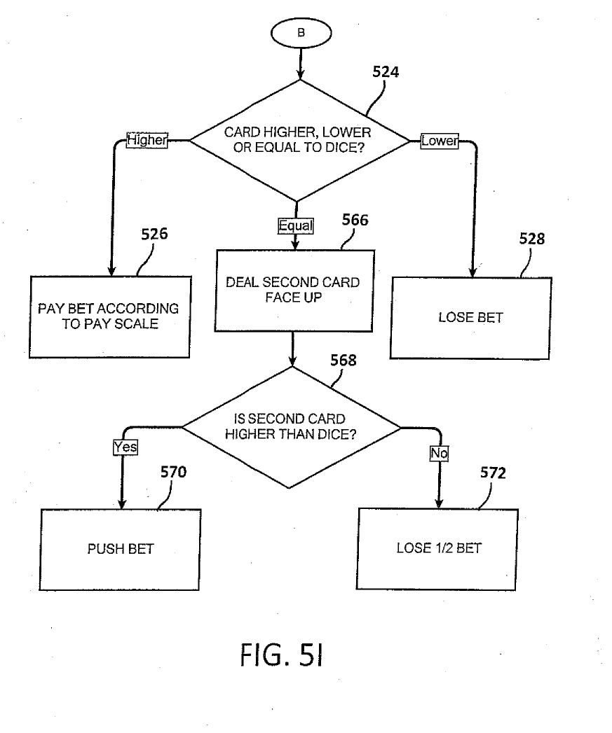

FIGS. 5A-5C illustrate a simplified process flow diagram of an embodiment of the invention where a die value is compared to a predetermined value as a starting point and a follow-up card value is used for comparison with the die value. Referring to FIGS. 5A-5C, the two dice are rolled thereby generating a die value. (Step 502) This die value will be a value between 2 and 12, inclusive, as determined by adding the values of the two dice. The dealer announces the result of the dice roll and marks the die value on the table, such as for example on the number grid 105 of FIG. 1. Next, a determination is made whether the die value is higher or lower or equal to a predetermined value, such as for example, the value seven (7). (Step 504) If the die value is equal to the predetermined value, then no wagering is allowed (step 506) and play resumes at the start of the game. If the die value is less than the predetermined value, the player decides whether to place a bet, and if so, places the bet on a designated location on the table, such as for example, on the third location 122 of FIG. 1. (Step 508) Next a single card is dealt face up from the one or more decks of shuffled cards thereby displaying a card value, which will be a value between 1 and 13, inclusive, as determined by the previously-described chart. (Step 510) The die value is compared with the card value, and a determination is made whether the die value is higher than the card value, lower than the card value or tied with the card value. (Step 512) If the card value is less than the die value, then the player wins and the bet is paid according to a first predetermined pay scale having a first plurality of payout odds that vary as a function of the die value. (Step 514) If the card value is greater than the die value, then the player loses and the wager is taken. (Step 516) On the other hand if the card and die values are equal, then at least a portion of the wager, such as for example one half (½) of the wager, is returned to the player with the house retaining the balance of the wager. (Step 518)

Returning now to step 504, if the die value is higher than the predetermined value (e.g., the value seven (7)) the player decides whether to place a bet, and if so, places the bet on the designated table location on the table. (Step 520) A single card is dealt face up thereby displaying a card value between 1 and 13, inclusive. (Step 522) The die value is compared with the card value, and a determination is made whether the die value is higher than the card value, lower than the card value or tied with the card value. (Step 524) If the card value is greater than the die value, then the player wins and the bet is paid according to a second predetermined pay scale having a second plurality of payout odds that vary as a function of the die value. (Step 526) If the card value is less than the die value, then the player loses and the wager is taken. (Step 528) On the other hand if the card and die values are equal, then at least a portion of the wager, such as for example one half (½) of the wager, is returned to the player with the house retaining the balance of the wager. (Step 530)

The table layout 102 of FIG. 1 provides a useful means for visualizing the play of the wagering game of the embodiment of FIGS. 5A-5C. As previously mentioned, after the roll of the dice the dealer uses a marker to mark the die value at the corresponding location on the number grid 105 of the table layout 102. With the marker thus placed, a player can easily see the likelihood of a winning bet and the corresponding payout odds that are associated with the die value. Thus for example if the die value was a value of ten (10), a marker would be placed on the square of the number grid 105 bearing the designation “10”. With the marker thus placed and knowing that the die value is greater than the predetermined value of seven (7), a player can quickly see that in order to win the bet, a card that is to be drawn from a deck will have to have a card value of 11, 12 or 13 (i.e., a Jack, Queen or King). Moreover if a winning card is drawn, the player can readily see that the payout would be 3 to 1, which is the payout shown among the first plurality of payout odds 124 at the location that is closest to the marker at the “10” location in the number grid 105.

Thus any bet associated with the embodiment of FIGS. 5A-5C is sometimes referred to as a “short side” bet. A short side bet corresponds to a player's prediction that in order to win, an upcoming card value will fall on the “short side” of the number grid 105. In the foregoing example where the die value is 10 and the marker is at the “10” location of the grid 105, then the grid 105 is effectively divided into a “short side” of the grid 105 comprised of the numbers 11-13 and a “long side” of the grid comprised of the numbers 1-9. As another example, if the die value was the value four (4), then the “long side” of the grid 105 would be the numbers 5-13 and the “short side” would be the numbers 1-3, any one of which would be a winning bet (with a payout of 3 to 1) if the upcoming card value is a 1, 2 or 3. Thus it can be seen that according to this embodiment, a card value must fall on the “short side” of the number grid 105 to win a wager, and the wager is paid out according to one of the payout odds in either the first or second plurality of payout odds 124, 126, as the case may be.

FIGS. 5D and 5E illustrate an alternative embodiment of the game that differs from the foregoing in the handling of ties, i.e., when the card and die values are the same. Referring first to FIG. 5D, the playing of the game is generally the same as previously described in connection with FIGS. 5A and 5B up to and including steps 512, 514 and 516. If however at step 512 it is determined that the card and die values are equal, then a determination is made whether the dice roll had been a roll of “doubles”, i.e., whether there had been rolled a pair of “1's”, a pair of “2's”, a pair of “3's”, a pair of “4's”, a pair of “5's” or a pair of “6's.” (Step 532) If there had been a roll of doubles, then there is a “push” of the wager, i.e., the player's wage is returned in full to the player without any winnings or loss. (Step 534) On the other hand if there had not been a roll of doubles, then the player loses at least a portion of the wager, such as for example one half (½) of the wager, and the balance is returned to the player. (Step 536)

Referring now to FIG. 5E, the playing of the game is generally the same as previously described in connection with FIGS. 5A and 5C up to and including steps 524, 526 and 528. If however at step 524 it is determined that the card and die values are equal, then a determination is made whether the dice roll had been a roll of doubles. (Step 538) If there had been a roll of doubles, then there is a “push” of the wager, i.e., the player's wager is returned in full to the player without any winnings or loss. (Step 540) On the other hand if there had not been a roll of doubles, then the player loses at least a portion of the wager, such as for example one half (½) of the wager, and the balance is returned to the player. (Step 542)

The embodiment of FIGS. 5D and 5E involves a question of whether or not there had been a roll of doubles to determine how much of the bet is lost by the player when the die value and the card value are the same. In yet another embodiment, one or more of the card suits (e.g., Spades, Hearts, Diamonds or Clubs as contained in a standard deck of 52 playing cards without jokers) is designated. The designation may be determined, for example, by the marking of a particular space on the playing surface, by drawing another card from a deck and using the suit of that card as the designation, or by displaying a sign or other indicia indicating the designated suit or suits at the table. Regardless of how the suit designation is determined, if the suit of the card that was dealt to determine the card value is the same as the previously-designated suit, then the wager is returned in full to the player when there is a tie. Otherwise a portion of the wager is lost such as, for example, one half (½) of the wager.

FIGS. 5A, 5F and 5G illustrate an embodiment involving the use of a designated suit for determining the nature of any return of a wager when there is a tie. Referring first to FIG. 5F, the playing of the game is generally the same as previously described in connection with FIGS. 5A and 5B up to and including steps 512, 514 and 516. If however at step 512 it is determined that the card and die values are equal, then a determination is made whether the suit of the card that was dealt in step 510 is the same as the designated suit. (Step 544) If the suit of the card is the same as the designated suit, then there is a push. (Step 548) On the other hand if the suit of the card is not the same as the designated suit, then the player loses at least a portion of the bet, such as for example one half (½) of the bet. (Step 550)

Referring to FIG. 5G, the playing of the game is generally the same as previously described in connection with FIGS. 5A and 5C up to and including steps 524, 526 and 528. If however at step 524 it is determined that the card and die values are equal, then a determination is made whether the suit of the card that was dealt in step 522 is the same as the designated suit. (Step 552) If the suit of the card is the same as the designated suit, then there is a push. (Step 554) On the other hand if the suit of the card is not the same as the designated suit, then the player loses at least a portion of the bet, such as for example one half (½) of the bet. (Step 556)

In yet another embodiment, any return of a wager arising from a tie is determined by dealing a second card thereby displaying a second card value. If the second value would have caused the wager to have won had the second card been dealt in place of the originally-dealt card, then at least a portion of the player's wager would be returned to the player. If the second card value would not have caused the wager to have won had the second card been dealt in place of the originally-dealt card, then at least a portion of the wager is lost such as, for example, one half (½) of the wager.

FIGS. 5H and 5I illustrate an embodiment involving the use of a second card for determining the nature of any return of a wager when there is a tie. Referring to FIG. 5H, the playing of the game is generally the same as previously described in connection with FIGS. 5A and 5B up to and including steps 512, 514 and 516. However according to this embodiment, if at step 512 it is determined that there is a tie, then a second card is dealt face up thereby displaying a second card value. (Step 558) The second card value is compared with the die value and a determination is made whether the second card value is lower than the die value. (Step 560) If the second card value is lower than the die value, then there is a push, and the wager is returned to the player. (Step 562) On the other hand if the second card value is higher than the die value or if the second card value is equal to the die value, then the player loses at least a portion of the wager such as, for example, one half (½) of the wager. (Step 564)

Referring to FIG. 5I, the playing of the game is generally the same as previously described in connection with FIGS. 5A and 5C up to and including steps 524, 526 and 528. However according to this embodiment, if at step 524 it is determined that there is a tie, then a second card is dealt face up thereby displaying a second card value. (Step 566) The second card value is compared with the die value and a determination is made whether the second card value is higher than the die value. (Step 568) If the second card value is higher than the die value, then there is a push, and the wager is returned to the player. (Step 570) On the other hand if the second card value is lower than the die value or if the second card value is equal to the die value, then the player loses at least a portion of the wager such as, for example, one half (½) of the wager. (Step 572)

In the embodiments of FIGS. 5A-5I, one or more dice are used for generating a generally random number for comparison with a card that is drawn from at least one, shuffled deck. In alternative embodiments, however, cards from special decks can be substituted for the one or more dice in order to generate a generally random number that would mimic the generally random number that results from the roll of one or more dice. In one embodiment, a first deck of cards is used in lieu of one die to generate a first card value, and a second deck of cards is used in lieu of a second die to generate a second card value. The first and second card values are summed to determine a combined card value. A third card is drawn from a third deck to determine a third card value. The combined card value and the third card value are compared for the play of the game. Winning bets (and the amounts of the payouts) are determined in generally the same fashion as the embodiments described above in connection with FIGS. 5A-5I.

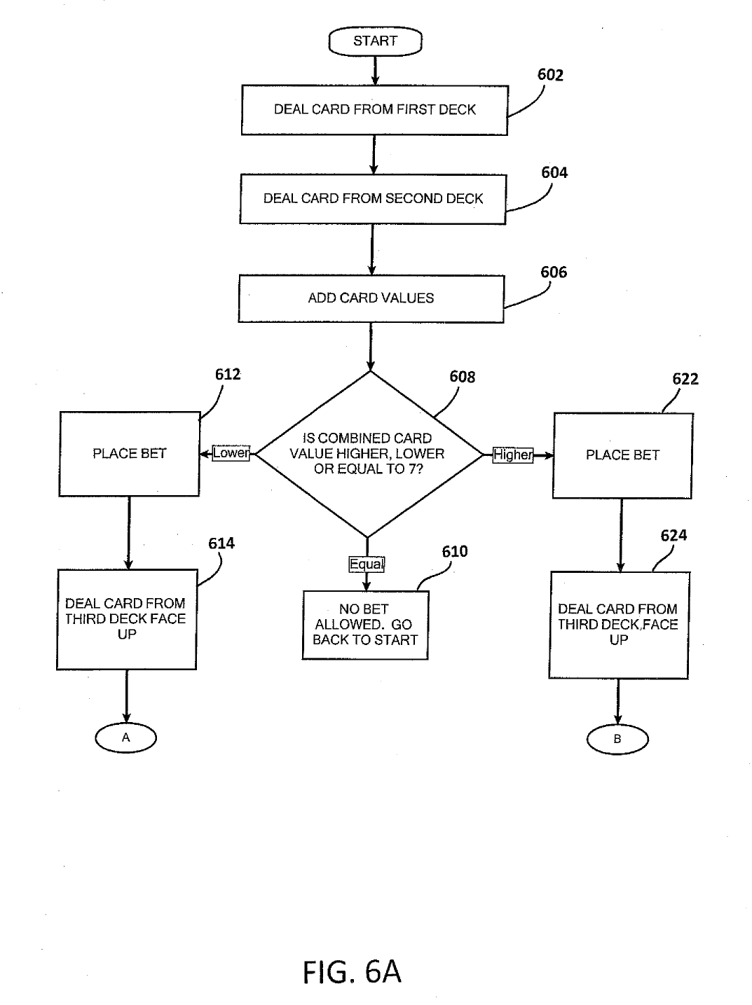

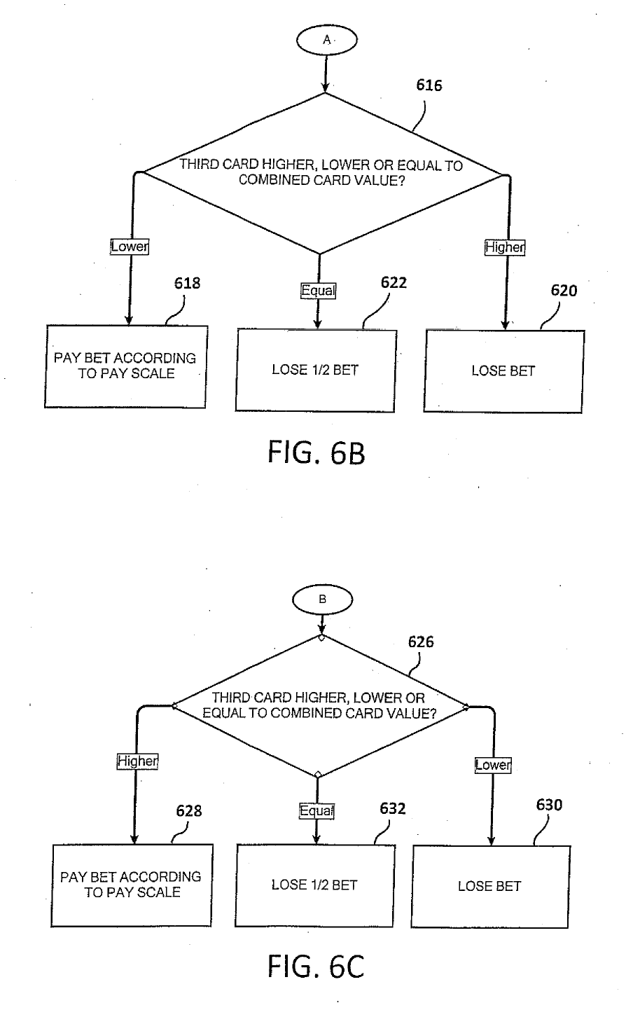

FIGS. 6A, 6B and 6C illustrate a simplified process flow diagram of an embodiment of the invention that uses a first deck of cards in lieu of a first die and a second deck of cards in lieu of a second die. The first and second decks are each limited to a plurality of cards having values between 1 and 6, inclusive. A first card is dealt face up from a first deck of cards thereby displaying a first card value between 1 and 6, inclusive. (Step 602) Then a second card is dealt face up from a second deck of cards thereby displaying a second card value between 1 and 6, inclusive. (Step 604) The first card value is added to the second card value to arrive at a combined card value between 2 and 12, inclusive. (Step 606) The dealer announces the combined card value and marks this value on the table, such as for example on the number grid 105 of FIG. 1. Next, a determination is made whether the combined card value is higher or lower or equal to a predetermined value, such as for example, the value seven (7). (Step 608) If the die value is equal to the predetermined value, then no wagering is allowed (step 610) and play resumes at the start of the game. If the combined card value is less than the predetermined value, the player decides whether to place a bet, and if so, places the bet on a designated location on the table, such as for example, on the third location 122 of FIG. 1. (Step 612)

Next a third card is dealt face up from a third deck comprised of one or more standard decks of shuffled cards, thereby displaying a third card value, which will be a value between 1 and 13, inclusive, as determined by the previously-described chart. (Step 614) The combined card value is compared with the third card value, and a determination is made whether the third card value is higher than the combined card value, lower than the combined card value or tied with the combined card value. (Step 616) If the third card value is less than the combined card value, then the player wins and the bet is paid according to a first predetermined pay scale having a first plurality of payout odds that vary as a function of the combined card value. (Step 618) If the card value is greater than the die value, then the player loses and the wager is taken. (Step 620) On the other hand if the third card and combined card values are equal, then at least a portion of the wager, such as for example one half (½) of the wager, is returned to the player with the house retaining the balance of the wager. (Step 622)

Returning now to step 608, if the combined card value is higher than the predetermined value (e.g., the value seven (7)) the player decides whether to place a bet, and if so, places the bet on the designated table location on the table. (Step 622) A third card is dealt face up from the third deck thereby displaying a third card value between 1 and 13, inclusive. (Step 624) The third card value is compared with the combined card value, and a determination is made whether the third card value is higher than the combined card value, lower than the combined card value or tied with the combined card value. (Step 626) If the third card value is greater than the combined card value, then the player wins and the bet is paid according to a second predetermined pay scale having a second plurality of payout odds that vary as a function of the die value. (Step 628) If the third card value is less than the combined value, then the player loses and the wager is taken. (Step 630) On the other hand if the third card and combined card values are equal, then at least a portion of the wager, such as for example one half (½) of the wager, is returned to the player with the house retaining the balance of the wager. (Step 632)

Alternative embodiments of the foregoing game involve other methods for determining any return of the wager as a result of a tie. These other methods are quite similar to those discussed above in connection with FIGS. 5A-51 for resolving a tie. Thus for example when the combined and third card values are equal, the wager is returned to the player if the first card value is the same as the second card value, a result which generally corresponds to the rolling of doubles of dice. On the other hand if the first and second card values are not the same, then only a portion of the wager such as, for example, one half (½) of the wager, is returned to the player. As yet another alternative when the combined and third card values are equal, the suit of the third card is compared to a designated suit, and the wager is returned to the player if the suits are the same. If they are not the same, then only a portion of the wager, such as, for example, one half (½) of the wager, is returned to the player.

As yet another alternative when the combined and third card values are equal, a fourth card is dealt face up from the third deck thereby displaying a fourth card value between 1 and 13, inclusive. The wager is returned to the player if the fourth card value is less than the combined card value and if the combined card value is less than the predetermined value. Similarly the wager is returned to the player if the fourth card value is greater than the combined card value and if the combined card value is greater than the predetermined value. If neither of the two foregoing scenarios occurs, then only a portion of the wager, for example one half (½) of the wager, is returned to the player.

The above disclosure includes embodiments where one bet is based upon a prediction of whether a future card value will be over or under a future die value. Other disclosed embodiments include a bet that wins: (a) if a card value is greater than a die value when the die value is greater than a predetermined value, such as for example a predetermined value of seven (7), or (b) if the card value is less than the die value when the die value is less than the predetermined value. Alternative embodiments, however, can generally include the use both of these types of bets in a single game.

Thus for example according to one embodiment, a first wager is made based upon a prediction of either a first game outcome or a second game outcome. The first game outcome is a future card value being less than a future die value, and the second game outcome is the future card value being greater than the future die value. At least one die is rolled thereby generating a present die value. At this point the player is provided with an option to establish a second wager, if the present die value is not equal to a predetermined value, such as for example, the value of seven (7). The option to make the second wager is not available if the present die value is the same as the predetermined value. After the player has made a decision on the option, and has placed the second wager if he/she decides to exercise the option (assuming it is available), a card is dealt thereby displaying a present card value.

The player wins the first wager if the present card value is less than the present die value and if the prediction is the first game outcome. The first wager also wins if the present card value is greater than the present die value and if the prediction is the second game outcome. Also the player wins any second wager that he/she may have made if the present card value is less than the present die value, and if the present die value is less than the predetermined value. Any winning second wager is paid out in accordance with a first predetermined pay scale having a first plurality of payout odds that vary as a function of the present die value. The second wager also wins if the present card value is greater than the present die value, and if the present die value is greater than the predetermined value. Any winning second wager is paid out in accordance with a second predetermined pay scale having a second plurality of payout odds that vary as a function of the present die value.

On the other hand the player loses the first wager: (a) if the present card value is less than the present die value and if the prediction is the second game outcome, or (b) if the present card value is greater than the present die value and if the prediction is the first game outcome. Also if the option to place the second wager was exercised, the player loses that wager: (a) if the present card value is less than the present die value and if the present die value is greater than the predetermined value, or (b) if the present card value is greater than the present die value and if the present die value is less than the predetermined value.

When there is a tie, i.e., when the present card value is equal to the present die value, then the various ways of resolving such a tie can be used in this embodiment as are described above in the previously disclosed embodiments of the invention. Moreover, while the second wager is optional in the foregoing embodiment, alternative embodiments include games where the second wager is not optional, so that it is a requirement for playing the game that both the first and second wagers be made. Also as yet a further alternative to the foregoing embodiment, cards from special decks can be substituted for the one or more dice in order to generate a generally random number that would mimic the generally random number that results from the roll of one or more dice. In one embodiment, a first deck of cards is used in lieu of one die to generate a first card value, and a second deck of cards is used in lieu of a second die to generate a second card value. The first and second card values are summed to determine a combined card value. A third card is drawn from a third deck to determine a third card value. The combined card value and the third card value are compared for the play of the game.

The above disclosure includes embodiments where one bet is based upon a prediction of whether a future card value will be over or under a future die value. Other disclosed embodiments include a bet that wins if a spread or difference between a die value and a card value is equal to or greater than a predetermined amount. Yet other disclosed embodiments include a bet that wins: (a) if a card value is greater than a die value when the die value is greater than a predetermined value, such as for example a predetermined value of seven (7), or (b) if the card value is less than the die value when the die value is less than the predetermined value. Alternative embodiments, however, generally include the use of all three of these types of bets in a single game.

Thus for example according to one embodiment, a first wager is established based upon a prediction of a first game outcome or a second game outcome, wherein the first game outcome is a future card value being less than a future die value, and wherein the second game outcome is the future card value being greater than the future die value. The first wager is placed on a betting location of a table such as, for example, the first location 112 of FIG. 1. A first option to establish a second wager is provided. If the first option is exercised, then the second wager is placed on another betting location of a table such as, for example, the second location 114 of FIG. 1. Then, at least one die is rolled thereby generating a present die value. The present die value is marked on the play table such as, for example, on an appropriate location of the number grid 105 of FIG. 1. After the rolling of the at least one die, a second option to establish a third wager is provided if the present die value is not equal to a first predetermined value. If the present die value equals the first predetermined value, then the second option is not available to the player. On the other hand if the second option is permitted and exercised by the player, then the third wager is placed on yet another location on the table such as, for example, the third location 122 of FIG. 1. Then a card is dealt thereby displaying a present card value.

The first wager is paid: (a) if the present card value is less than the present die value and if the prediction is the first game outcome, or (b) if the present card value is greater than the present die value and if the prediction is the second game outcome. The second wager is paid if the first option was exercised and if a difference between the present die value and the present card value is greater than or equal to a second predetermined value. Any paying of the second wager is in accordance with a first predetermined pay scale having a first plurality of payout odds that increase in payout as the magnitude of the difference between the present card value and the present die value increases.

The third wager is paid if the second option was exercised (when permitted) and if the present card value is less than the present die value and if the present die value is less than the first predetermined value. Under these conditions the payout of the third wager is in accordance with a second predetermined pay scale having a second plurality of payout odds that increase in payout as the present die value decreases in value. The third wager also is paid if the second option was exercised (when permitted), if the present card value is greater than the present die value and if the present die value is greater than the first predetermined value. Under these conditions the payout of the third wager is in accordance with a third predetermined pay scale having a third plurality of payout odds that increase in payout as the present die value increases in value. Using an embodiment with the play table illustrated in FIG. 1, the pluralities of payout odds are shown by reference numerals 124 and 126.

According to the foregoing embodiment involving up to three wagers, the first wager is taken or lost: (a) if the present card value is less than the present die value and if the prediction is the second game outcome, or (b) if the present card value is greater than the present die value and if the prediction is the first game outcome. The second wager is taken if the first option was exercised and if the difference between the present die value and the present card value is less than the second predetermined value. Finally, the third wager is taken: (a) if the second option was exercised and if the present card value is greater than the present die value and if the present die value is less than the first predetermined value, or (b) if the second option was exercised and if the present card value is less than the present die value and if the present die value is greater than the first predetermined value.

When there is a tie, i.e., when the present card value is equal to the present die value, then any of the various ways of resolving such a tie, as are described above in the previously-disclosed embodiments of the invention, can be used in this embodiment. Moreover, while the second and third wagers are optional in the foregoing embodiment, alternative embodiments include games where one or both of the second and third wagers are not optional, so that it is a requirement for playing the game that the first wager along with one or both of the second and third wagers be made. Also as yet a further alternative to the foregoing embodiment, cards from special decks can be substituted for the one or more dice in order to generate a generally random number that would mimic the generally random number that results from the roll of one or more dice. In one embodiment, a first deck of cards is used in lieu of one die to generate a first card value, and a second deck of cards is used in lieu of a second die to generate a second card value. The first and second card values are summed to determine a combined card value. A third card is drawn from a third deck to determine a third card value. The combined card value and the third card value are compared for the play of the game.

With general reference to the embodiments of FIGS. 2A-2E, 3A-3C, 4A-4C, 5A-5I and 6A-6C, as previously mentioned in some of those embodiments one or more dice are used for producing a generally random number for comparison with the value of a card that is drawn from at least one shuffled deck. In alternative embodiments, cards can be substituted for the one or more dice in order to generate a generally random number that mimics the generally random number generated by rolling one or more dice. When a plurality of players is playing with one dealer, the card or cards that are drawn from the deck(s) can apply to all players for each round of betting. Thus the same card value(s) is applicable to all players. In alternative embodiments however, the dealer can deal the cards so that each of the plurality of players receives his/her own card(s) for each round of betting. Thus there are different card values appearing on the table wherein each of the card values is applicable to a different player.

Some of the embodiments described above generally in connection with FIGS. 2A-2E, 3A-3C, 4A-4C, 5A-5I and 6A-6C involve a payout odds of 1 to 1, and in some instances a payout odds according to one or more predetermined pay scales having a plurality of payout odds such as, for example, those shown in the above-illustrated pay tables. It will be appreciated that the invention is not limited to these payout odds only, but rather alternative embodiments can employ payout odds that are other than 1 to 1 and/or other than the odds shown in the above pay tables. Moreover, while many of the above-described embodiments involve the use of at least one standard deck of 52 playing cards, alternative styles or types of cards can be used wherein each of the cards nevertheless has indicia corresponding to a point value between 1 and 13, inclusive. Alternatively still, yet other types of cards can be used wherein each of the cards has indicia corresponding to a point value involving a different range of numbers or values. Similarly, alternative embodiments are not limited to two, standard six-sided dice. Rather these embodiments can employ two, non-standard dice, or only one standard or non-standard die, or three or more standard or non-standard dice. Also these embodiments can involve one or more dice that would yield die values having ranges of values other than 2 through 12.

The foregoing disclosure generally pertains to playing wagering games using cards and/or dice in a live table format. However the embodiments described herein can be implemented in a computing and software environment for playing in an electronic video format. The following describes an exemplary operating environment in the general context of a machine or personal computer on which is running an operating system and one or more application programs. However it will be recognized that embodiments of the invention can be implemented with other machines or hardware devices, such as for example hand-held devices; computerized, special-purpose gaming machines; mainframe computers; minicomputers; microprocessor-based consumer electronics; set top boxes; etc. Moreover, these computers or other devices can be interconnected so that they may communicate via a network, including a wide area network (WAN), a large area network (LAN), the Internet, etc. Such communications can be via wireless or wired connections. The one or more software application programs can include data structures, components, applets, program modules, routines, programs, objects, etc., that can all reside on at least one non-transitory computer readable storage medium or on one machine, or alternatively, can be distributed over a plurality of machines, some or all of which can be in communication with one another.

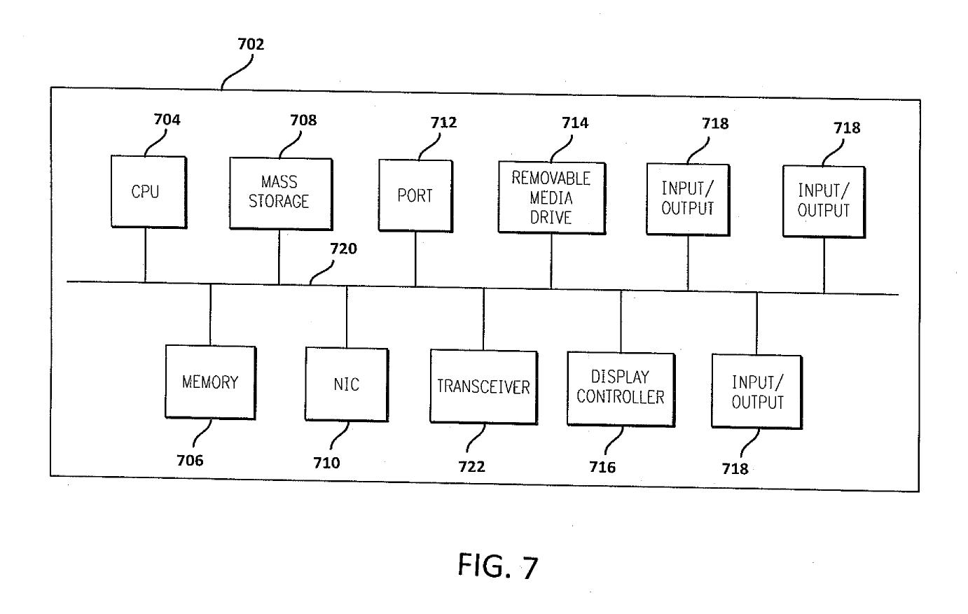

FIG. 7 is a functional block diagram of a computer 702 according to an embodiment of the invention. The computer 702 is used to receive betting-related information and input from a player, etc. The computer 702 also provides text and images on a display relating to the playing of wagering games, such as for example images of cards and/or dice, of playing chips or currency, pay scale odds, betting amounts, etc.

The computer 702 includes a central processing unit (CPU) 704 coupled to a system memory 706, preferably including both high speed random access memory (RAM) and non-volatile memory, such as read only memory (ROM), erasable or alterable non-volatile memory (e.g., flash memory). The CPU 704 is further coupled to a mass storage device 708, such as a hard disk drive, which is a non-transitory computer readable storage medium and which is for storing operating system programs, data, cryptographic keys, application programs, etc. The computer 702 further includes one or more input/output devices, including, for example, a network interface card (NIC) 710 for wired connections and a transceiver 722 for wireless connections, either or both of which can be for communicating with other devices via a network, such as for example the Internet.

A port 712 for connecting to a portable device, another computer, or other peripheral device, is also included along with one or more removable media drives 714 for reading from, and/or writing to, e.g., diskettes, compact discs, flash drives, DVDs, or other non-transitory computer readable storage media. User interfaces include a display screen controller 716 and a plurality of input and output devices 718, such as, for example, a keyboard, a mouse, a touch screen, a microphone, a sound generator, and a joystick, as well as specialized, gaming-related input/output devices such as currency or playing chip receivers (e.g., coin hoppers, coin acceptors, bill validators, etc.), credit/debit card readers, currency or playing chip dispensers, ticket printers or dispensers, player controls, etc. A bi-directional bus 720 interconnects the above-described components of the system.

The operation of the computer 702 is controlled primarily by programs contained in the system memory 706 and executed by the CPU 704. These programs include program modules for accepting input data and for processing the input data in accordance with the embodiments of the invention described herein. For example, the program includes one or more program modules for instructing the CPU 704 to perform certain actions and for receiving betting amount and decision inputs from a player via one or more of the various input/output devices 718, and for providing the player with text and images of cards, dice, betting odds, betting status, payout information, etc. via the display controller 716. It will be appreciated, however, that some or all of the functionality of these program modules could be readily implemented in hardware without departing from the principles of the present inventions.

In view of the above, it will be appreciated that embodiments of the invention provide an enjoyable wagering game that allows a player to bet on the basis of a comparison of dice and card values. According to one embodiment dice are thrown or rolled to provide a die value between 2 and 12, inclusive. If the die value is equal to a predetermined value, which in this embodiment is a value of seven (7), no betting is permitted, and the dice again are rolled and the process repeated until a die value which is not a seven (7) is rolled. After a successful roll of the dice, the die value is marked on a number grid located on a playing surface and displaying numbers ranging from 1 to 13, inclusive. After the player makes a wager, a card is dealt face up from one or more decks of playing cards, thereby displaying a card value of 1 to 13, inclusive.

The player wins the wager if the card value is less than the die value and if the die value is less than the predetermined value of seven (7). Similarly the player wins the wager if the card value is greater than the die value and if the die value is greater than the predetermined value of seven (7). Otherwise the player loses the wager. If there is a tie (i.e., if the die value and the card value are equal), then one half (½) of the wager is returned to the player unless dice doubles were rolled, in which case the entire wager is returned.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A method of playing a wagering game, comprising:
rolling at least one die thereby generating a die value;
establishing a wager;
dealing a card thereby displaying a card value;
paying the wager if the card value is less than the die value and if the die value is less than a predetermined value; and
paying the wager if the card value is greater than the die value and if the die value is greater than the predetermined value.

2. The method of claim 1 wherein the die value is a value between 2 and 12, inclusive, wherein the card value is a value between 1 and 13, inclusive, and wherein the predetermined value is a value of seven (7).

3. The method of claim 1 wherein the dealing of the card includes dealing the card from at least one standard deck of 52 cards, wherein each card of the at least one standard deck of 52 cards has a point value between 1 and 13, inclusive, wherein the rolling of the at least one die includes rolling two dice each having six faces numbered one to six, and wherein the die value is a value between 2 and 12, inclusive.

4. The method of claim 1 wherein the paying of the wager if the card value is less than the die value and if the die value is less than the predetermined value includes paying the wager in accordance with a first predetermined pay scale having a first plurality of payout odds that vary as a function of the die value, and
wherein the paying of the wager if the card value is greater than the die value and if the die value is greater than the predetermined value includes paying the wager in accordance with a second predetermined pay scale having a second plurality of payout odds that vary as a function of the die value.

5. The method of claim 4 wherein the variance as the function of the die value in the first predetermined pay scale is an increase in the payout odds corresponding to a decrease in the die value, and wherein the variance as the function of the die value in the second predetermined pay scale is an increase in the payout odds corresponding to an increase in the die value.

6. The method of claim 1 wherein the predetermined value is a value of seven (7), wherein the paying of the wager if the card value is less than the die value and if the die value is less than the predetermined value includes paying the wager according to the following schedule:

| Die Value | Payout Odds |
|---|---|
| 6 | 7 to 5 |
| 5 | 2 to 1 |
| 4 | 3 to 1 |
| 3 | 5 to 1 |
| 2 | 11 to 1 |

and wherein paying the wager if the card value is greater than the die value and if the die value is greater than the predetermined value includes paying the wager according to the following schedule:

| Die Value | Payout Odds |
|---|---|
| 8 | 7 to 5 |
| 9 | 2 to 1 |
| 10 | 3 to 1 |
| 11 | 5 to 1 |
| 12 | 11 to 1 |

7. The method of claim 1 further comprising:
taking the wager if the die value is less than the predetermined value and if the card value is greater than the die value; and
taking the wager if the die value is greater than the predetermined value and if the card value is less than the die value.

8. The method of claim 1 further comprising taking the wager if the die value is equal to the card value.

9. The method of claim 1 further comprising returning at least a portion of the wager if the die value is equal to the card value.

10. The method of claim 9 wherein the die value is a combined die value, wherein the rolling of the at least one die comprises rolling a first die thereby generating a first die value and rolling a second die thereby generating a second die value,
wherein the combined die value is the sum of the first die value and the second die value,
wherein the returning of the at least the portion of the wager includes returning all of the wager if the first die value is equal to the second die value, and returning one half (½) of the wager if the first die value is not equal to the second die value.

11. The method of claim 9 wherein the dealing of the card includes dealing the card from a deck comprised of a plurality of cards having a plurality of suits, wherein the returning of the at least the portion of the wager includes returning all of the wager if the card is of a suit that is the same as a designated suit, and returning one half (½) of the wager if the card is of a suit that is not the same as the designated suit.

12. The method of claim 1 wherein the card is a first card, the method further comprising:
dealing a second card if the card value is equal to the die value, wherein the dealing of the second card thereby displays a second card value,
returning all of the wager if the die value is less than the predetermined value and if the second card value is less than the die value;
returning one half (½) of the wager if die value is less than the predetermined value and if the second card value is equal to or greater than the die value;
returning all of the wager if the die value is greater than the predetermined value and if the second card value is greater than the die value; and
returning one half (½) of the wager if the die value is greater than the predetermined value and if the second card value is equal to or less than the die value.

13. A method of playing a wagering game, comprising:
dealing a first card from a first deck thereby displaying a first card value between 1 and 6, inclusive;
dealing a second card from a second deck thereby displaying a second card value between 1 and 6, inclusive;
wherein the sum of the first card value and the second card value is a combined card value between 2 and 12, inclusive;
establishing a wager;
dealing a third card from a third deck thereby displaying a third card value between 1 and 13, inclusive;
paying the wager if the third card value is less than the combined card value and if the combined card value is less than a predetermined value; and
paying the wager if the third card value is greater than the combined card value and if the combined card value is greater than the predetermined value.

14. The method of claim 13 wherein the predetermined value is a value of seven (7).

15. The method of claim 13 wherein the paying of the wager if the third card value is less than the combined card value and if the combined card value is less than the predetermined value includes paying the wager in accordance with a first predetermined pay scale having a first plurality of payout odds that vary as a function of the combined card value, and
wherein the paying of the wager if the third card value is greater than the combined card value and if the combined card value is greater than the predetermined value includes paying the wager in accordance with a second predetermined pay scale having a second plurality of payout odds that vary as a function of the combined card value.

16. The method of claim 15 wherein the variance as the function of the combined card value in the first predetermined pay scale is an increase in the payout odds corresponding to a decrease in the combined card value, and wherein the variance as the function of the combined card value in the second predetermined pay scale is an increase in the payout odds corresponding to an increase in the combined card value.

17. The method of claim 13 further comprising:
taking the wager if the combined card value is less than the predetermined value and if the third card value is greater than the combined card value; and
taking the wager if the combined card value is greater than the predetermined value and if the third card value is less than the combined card value.

18. The method of claim 13 further comprising taking the wager if the combined card value is equal to the third card value.

19. The method of claim 13 further comprising returning at least a portion of the wager if the combined card value is equal to the third card value.

20. The method of claim 19 wherein the returning of the at least the portion of the wager includes returning all of the wager if the first card value is equal to the second card value, and returning one half (½) of the wager if the first card value is not equal to the second card value.

21. The method of claim 19 wherein the third deck is comprised of a plurality of cards having a plurality of suits and wherein the returning of the at least the portion of the wager includes returning all of the wager if the third card is of a suit that is the same as a designated suit, and returning one half (½) of the wager if the third card is of a suit that is not the same as the designated suit.

22. The method of claim 13 further comprising:
dealing a fourth card from the third deck if the third card value is equal to the combined card value, wherein the dealing of the fourth card thereby displays a fourth card value,
returning all of the wager if the combined card value is less than the predetermined value and if the fourth card value is less than the combined card value;
returning one half (½) of the wager if combined card value is less than the predetermined value and if the fourth card value is equal to or greater than the combined card value;
returning all of the wager if the combined card value is greater than the predetermined value and if the fourth card value is greater than the combined card value; and
returning one half (½) of the wager if the combined card value is greater than the predetermined value and if the fourth card value is equal to or less than the combined card value.

23. An article of manufacture for use in playing a wagering game and for use by a device having a processing unit, said article of manufacture comprising at least one non-transitory computer readable storage medium including at least one computer program embedded therein for use by the device, wherein the at least one computer program instructs the processing unit to perform actions comprising:
displaying at least one die showing a die value;
establishing a wager;
displaying a card showing a card value;
paying the wager if the card value is less than the die value and if the die value is less than a predetermined value; and
paying the wager if the card value is greater than the die value and if the die value is greater than the predetermined value.

24. The article of manufacture of claim 23 wherein the die value is a value between 2 and 12, inclusive, wherein the card value is a value between 1 and 13, inclusive, and wherein the predetermined value is a value of seven (7).

25. The article of manufacture of claim 23 wherein the paying of the wager if the card value is less than the die value and if the die value is less than the predetermined value includes paying the wager in accordance with a first predetermined pay scale having a first plurality of payout odds that vary as a function of the die value, and
wherein the paying of the wager if the card value is greater than the die value and if the die value is greater than the predetermined value includes paying the wager in accordance with a second predetermined pay scale having a second plurality of payout odds that vary as a function of the die value.

26. The article of manufacture of claim 25 wherein the variance as the function of the die value in the first predetermined pay scale is an increase in the payout odds corresponding to a decrease in the die value, and wherein the variance as the function of the die value in the second predetermined pay scale is an increase in the payout odds corresponding to an increase in the die value.

27. The article of manufacture of claim 23 further comprising:
taking the wager if the die value is less than the predetermined value and if the card value is greater than the die value; and
taking the wager if the die value is greater than the predetermined value and if the card value is less than the die value.

28. The article of manufacture of claim 23 further comprising taking the wager if the die value is equal to the card value.

29. The article of manufacture of claim 23 further comprising returning at least a portion of the wager if the die value is equal to the card value.

30. A machine for use in playing a wagering game, comprising:
a memory;
a processing unit coupled to the memory; and
an application stored in the memory and operable with the processing unit to perform steps comprising:
displaying at least one die showing a die value;
establishing a wager;
displaying a card showing a card value;
paying the wager if the card value is less than the die value and if the die value is less than a predetermined value; and
paying the wager if the card value is greater than the die value and if the die value is greater than the predetermined value.

31. The machine of claim 30 wherein the die value is a value between 2 and 12, inclusive, wherein the card value is a value between 1 and 13, inclusive, and wherein the predetermined value is a value of seven (7).

32. The machine of claim 30 wherein the paying of the wager if the card value is less than the die value and if the die value is less than the predetermined value includes paying the wager in accordance with a first predetermined pay scale having a first plurality of payout odds that vary as a function of the die value, and
wherein the paying of the wager if the card value is greater than the die value and if the die value is greater than the predetermined value includes paying the wager in accordance with a second predetermined pay scale having a second plurality of payout odds that vary as a function of the die value.

33. The machine of claim 32 wherein the variance as the function of the die value in the first predetermined pay scale is an increase in the payout odds corresponding to a decrease in the die value, and wherein the variance as the function of the die value in the second predetermined pay scale is an increase in the payout odds corresponding to an increase in the die value.

34. The machine of claim 30 further comprising:
taking the wager if the die value is less than the predetermined value and if the card value is greater than the die value; and
taking the wager if the die value is greater than the predetermined value and if the card value is less than the die value.

35. The machine of claim 30 further comprising taking the wager if the die value is equal to the card value.

36. The machine of claim 30 further comprising returning at least a portion of the wager if the die value is equal to the card value.

37. A method of playing a wagering game, comprising:
establishing a first wager based upon a prediction of one of a first game outcome and a second game outcome, wherein the first game outcome is a future third card point value being less than a future combined card point value, and wherein the second game outcome is the future third card point value being greater than the future combined card point value;
dealing a first card from a first deck thereby displaying a first card point value between 1 and 6, inclusive;
dealing a second card from a second deck thereby displaying a second card point value between 1 and 6, inclusive, wherein the sum of the first card point value and the second card point value is a present combined card point value;
dealing a third card from a third deck thereby displaying a present third card point value between 1 and 13, inclusive;
paying the first wager if the present third card point value is less than the present combined card point value and if the prediction is the first game outcome;
paying the first wager if the present third card point value is greater than the present combined card point value and if the prediction is the second game outcome; and
returning at least one half of the wager if the present third card value is equal to the present combined card point value.

38. The method of claim 37 wherein the returning of the at least one half of the wager includes returning all of the wager if the first card point value is equal to the second card point value, and returning one half (½) of the wager if the first card point value is not equal to the second card point value.

39. The method of claim 37 wherein the third deck is comprised of a plurality of cards having a plurality of suits, and wherein the returning of the at least one half of the wager includes returning all of the wager if the third card is of a suit that is the same as a designated suit, and returning one half (½) of the wager if the third card is of a suit that is not the same as the designated suit.

40. The method of claim 37 further comprising:
dealing a fourth card from the third deck if the present third card value is equal to the present combined card value, wherein the dealing of the fourth card thereby displays a fourth card value,
wherein the returning of the at least one half of the wager includes:
returning all of the wager if the fourth card value is greater than the present combined card value and if the prediction is the second game outcome;
returning all of the wager if the fourth card value is less than the present combined card value and if the prediction is the first game outcome;
returning one half (½) of the wager if the fourth card value is greater than the present combined card value and if the prediction is the first game outcome; and
returning one half (½) of the wager if the fourth card value is less than the present combined card value and if the prediction is the second game outcome.

41. A method of playing a wagering game, comprising:
establishing a first wager based upon a prediction of one of a first game outcome and a second game outcome, wherein the first game outcome is a future card value being less than a future die value, and wherein the second game outcome is the future card value being greater than the future die value;
rolling at least one die thereby generating a present die value;
establishing a second wager;
dealing a card thereby displaying a present card value;
paying the first wager if the present card value is less than the present die value and if the prediction is the first game outcome;
paying the first wager if the present card value is greater than the present die value and if the prediction is the second game outcome;
paying the second wager if the present card value is less than the present die value and if the present die value is less than a predetermined value; and
paying the second wager if the present card value is greater than the present die value and if the present die value is greater than the predetermined value.

42. A method of playing a wagering game, comprising:
establishing a first wager based upon a prediction of one of a first game outcome and a second game outcome, wherein the first game outcome is a future card value being less than a future die value, and wherein the second game outcome is the future card value being greater than the future die value;
rolling at least one die thereby generating a present die value;
providing an option to establish a second wager if the present die value is not equal to a predetermined value, wherein the providing of the option is after the rolling of the at least one die;
dealing a card thereby displaying a present card value;
paying the first wager if the present card value is less than the present die value and if the prediction is the first game outcome;
paying the first wager if the present card value is greater than the present die value and if the prediction is the second game outcome;
paying the second wager if the option was exercised and if the present card value is less than the present die value and if the present die value is less than the predetermined value; and
paying the second wager if the option was exercised and if the present card value is greater than the present die value and if the present die value is greater than the predetermined value.

43. The method of claim 42 wherein the dealing of the card includes dealing the card from at least one standard deck of 52 cards, wherein each card of the at least one standard deck of 52 cards has a point value between 1 and 13, inclusive, wherein the rolling of the at least one die includes rolling two dice each having six faces numbered one to six, and wherein the die value is a value between 2 and 12, inclusive, and wherein the predetermined value is a value of seven (7).

44. The method of claim 42 further comprising:
taking the first wager if the present card value is less than the present die value and if the prediction is the second game outcome; and
taking the first wager if the present card value is greater than the present die value and if the prediction is the first game outcome.

45. The method of claim 42 further comprising:
taking the second wager if the option was exercised, if the present card value is less than the present die value and if the present die value is greater than the predetermined value; and
taking the second wager if the option was exercised, if the present card value is greater than the present die value and if the present die value is less than the predetermined value.

46. The method of claim 42 wherein the paying of the second wager if the option was exercised, if the present card value is less than the present die value and if the present die value is less than the predetermined value includes paying the second wager in accordance with a first predetermined pay scale having a first plurality of payout odds that vary as a function of the present die value, and
wherein the paying of the second wager if the option was exercised, if the present card value is greater than the present die value and if the present die value is greater than the predetermined value includes paying the second wager in accordance with a second predetermined pay scale having a second plurality of payout odds that vary as a function of the present die value.

47. The method of claim 46 wherein the variance as the function of the present die value in the first predetermined pay scale is an increase in the payout odds corresponding to a decrease in the present die value, and wherein the variance as the function of the present die value in the second predetermined pay scale is an increase in the payout odds corresponding to an increase in the present die value.

48. The method of claim 42 further comprising:
taking the first wager if the present die value is equal to the present card value; and
taking the second wager if the option was exercised and if the present die value is equal to the present card value.

49. The method of claim 42 further comprising:
returning at least a portion of the first wager if the present die value is equal to the present card value, and
returning at least a portion of the second wager if the option was exercised and if the present die value is equal to the present card value.

50. The method of claim 49 wherein the present die value is a combined die value, wherein the rolling of the at least one die comprises rolling a first die thereby generating a first die value and rolling a second die thereby generating a second die value,
wherein the combined die value is the sum of the first die value and the second die value,
wherein the returning of the at least the portion of the first wager includes returning all of the first wager if the first die value is equal to the second die value, and returning one half (½) of the first wager if the first die value is not equal to the second die value, and
wherein the returning of the at least the portion of the second wager includes returning all of the second wager if the first die value is equal to the second die value, and returning one half (½) of the second wager if the first die value is not equal to the second die value.

51. The method of claim 49 wherein the dealing of the card includes dealing the card from a deck comprised of a plurality of cards having a plurality of suits,
wherein the returning of the at least the portion of the first wager includes returning all of the first wager if the card is of a suit that is the same as a designated suit, and returning one half (½) of the first wager if the card is of a suit that is not the same as the designated suit, and
wherein the returning of the at least the portion of the second wager includes returning all of the second wager if the card is of a suit that is the same as a designated suit, and returning one half (½) of the second wager if the card is of a suit that is not the same as the designated suit.

52. The method of claim 42 wherein the card is a first card, the method further comprising:
dealing a second card if the present card value is equal to the present die value, wherein the dealing of the second card thereby displays a second present card value,
returning all of the first wager if the second present card value is greater than the present die value and if the prediction is the second game outcome;
returning one half (½) of the first wager if the second present card value is equal to or greater than the present die value and if the prediction is the first game outcome;
returning all of the first wager if the second present card value is less than the present die value and if the prediction is the first game outcome;
returning one half (½) of the first wager if the second present card value is equal to or less than the present die value and if the prediction is the second game outcome;
returning all of the second wager if the option was exercised, if the present die value is less than the predetermined value and if the second present card value is less than the present die value;
returning one half (½) of the second wager if the option was exercised, if the present die value is less than the predetermined value and if the second present card value is equal to or greater than the present die value;
returning all of the second wager if the option was exercised, if the present die value is greater than the predetermined value and if the second present card value is greater than the present die value; and
returning one half (½) of the second wager if the option was exercised, if the present die value is greater than the predetermined value and if the second present card value is equal to or less than the present die value.

53. A method of playing a wagering game, comprising:
establishing a first wager based upon a prediction of one of a first game outcome and a second game outcome, wherein the first game outcome is a future card value being less than a future die value, and wherein the second game outcome is the future card value being greater than the future die value;
providing a first option to establish a second wager;
rolling at least one die thereby generating a present die value;
providing a second option to establish a third wager if the present die value is not equal to a first predetermined value, wherein the providing of the second option is after the rolling of the at least one die;
dealing a card thereby displaying a present card value;
paying the first wager if the present card value is less than the present die value and if the prediction is the first game outcome;
paying the first wager if the present card value is greater than the present die value and if the prediction is the second game outcome; and
paying the second wager if the first option was exercised and if a difference between the present die value and the present card value is greater than or equal to a second predetermined value;
paying the third wager if the second option was exercised and if the present card value is less than the present die value and if the present die value is less than the first predetermined value; and
paying the third wager if the second option was exercised and if the present card value is greater than the present die value and if the present die value is greater than the first predetermined value.

54. The method of claim 53 further comprising:
taking the first wager if the present card value is less than the present die value and if the prediction is the second game outcome;
taking the first wager if the present card value is greater than the present die value and if the prediction is the first game outcome;
taking the second wager if the first option was exercised and if the difference between the present die value and the present card value is less than the second predetermined value;
taking the third wager if the second option was exercised and if the present card value is greater than the present die value and if the present die value is less than the first predetermined value; and
taking the third wager if the second option was exercised and if the present card value is less than the present die value and if the present die value is greater than the first predetermined value.

55. The method of claim 54 wherein the dealing of the card includes dealing the card from at least one standard deck of 52 cards, wherein each card of the at least one standard deck of 52 cards has a point value between 1 and 13, inclusive, wherein the rolling of the at least one die includes rolling two dice each having six faces numbered one to six, and wherein the present die value is a value between 2 and 12, inclusive, and wherein the first predetermined value is a value of seven (7) and wherein the second predetermined value is a value of six (6).

56. The method of claim 54 further comprising;
returning at least a portion of the first wager if the present card value is equal to the present die value; and
returning at least a portion of the third wager if the present card value is equal to the present die value.

57. The method of claim 54 wherein the present die value is a combined die value, wherein the rolling of the at least one die comprises rolling a first die thereby generating a first die value and rolling a second die thereby generating a second die value, and wherein the combined die value is the sum of the first die value and the second die value, the method further comprising:
returning all of the first wager and all of the third wager if the combined die value is equal to the present card value and if the first die value is equal to the second die value; and
returning one half (½) of the first wager and one half (½) of the third wager if the combined die value is equal to the present card value and if the first die value is not equal to the second die value.

58. The method of claim 54 wherein the paying of the second wager includes paying the second wager in accordance with a first predetermined pay scale having a first plurality of payout odds that vary as a function of the magnitude of the difference between the present card value and the present die value, wherein the function of the magnitude of the difference is an increase in the payout odds corresponding to an increase in the magnitude of the difference between the present card value and the present die value,
wherein the paying of the third wager if the present card value is less than the present die value and if the present die value is less than the first predetermined value includes paying the third wager in accordance with a second predetermined pay scale having a second plurality of payout odds that vary as a function of the present die value, wherein the variance as the function of the present die value in the second predetermined pay scale is an increase in the payout odds corresponding to a decrease in the present die value, and
wherein the paying of the third wager if the present card value is greater than the present die value and if the present die value is greater than the first predetermined value includes paying the third wager in accordance with a third predetermined pay scale having a third plurality of payout odds that vary as a function of the present die value, wherein the variance as the function of the present die value in the third predetermined pay scale is an increase in the payout odds corresponding to an increase in the present die value.
